(19) United States
(12) Patent Application Publication
(10) Pub. No.: US 2026/0233661 A1
(43) Pub. Date: Aug. 13, 2026

(54) VEHICLE SLEEPING PLATFORMS

(71) Applicant: FORD GLOBAL TECHNOLOGIES, LLC, Dearborn, MI (US)

(72) Inventors: Michael John Harmon, Northville, MI (US); Robert J. Gelardi, Plymouth, MI (US); Abbas Ghamlouche, Dearborn, MI (US); Will Farrelly, Chelmsford (GB); John Abernethy, Ingatestone (GB)

(21) Appl. No.: 19/049,296

(22) Filed: Feb. 10, 2025

(51) Int. Cl. B60P 3/39; B60J 7/043; E04H 15/06; E04H 15/50

(52) U.S. Cl. CPC B60P 3/39; B60J 7/043; E04H 15/06; E04H 15/50

(57) ABSTRACT

A device may include a vehicle roof panel. A device may include a mounting system secured to the vehicle roof panel. A device may include a sleeping platform supported on the mounting system, the sleeping platform moveable between a folded position and an unfolded position, the sleeping platform including a base portion and support legs, the support legs configured to attach to attachment points on a vehicle hood when in the unfolded position.

### TECHNICAL FIELD

This disclosure relates generally to vehicles, and more particularly to sleeping platforms for vehicles.

### BACKGROUND

Vehicle owners often use their vehicles for more than just transportation. For example, some vehicle owners may desire to sleep on or in their vehicle when camping or enjoying other outdoor activities while the vehicle is stationary and in a parked mode.

### SUMMARY

In some aspects, the techniques described herein relate to a vehicle sleeping system, including: a vehicle roof panel; a mounting system secured to the vehicle roof panel; and a sleeping platform supported on the mounting system, the sleeping platform moveable between a folded position and an unfolded position, the sleeping platform including a base portion and support legs, the support legs configured to attach to attachment points on a vehicle hood when in the unfolded position.

In some aspects, the techniques described herein relate to a vehicle sleeping system, wherein the base portion includes a first base section and a second base section that is pivotably attached to the first base section.

In some aspects, the techniques described herein relate to a vehicle sleeping system, wherein the support legs each include a first end and an opposite second end, the first end pivotably attached to a first side of the first base section at a first location, the second end releasably attached to the first side of the first base section at a second location.

In some aspects, the techniques described herein relate to a vehicle sleeping system, further including cross bars attached to a first side of the second base section, the cross bars configured to support the sleeping platform above the vehicle roof panel.

In some aspects, the techniques described herein relate to a vehicle sleeping system, wherein a first one of the cross bars is positioned on a forward portion of the second base section, a second one of the cross bars is positioned on a middle portion of the second base section, and a third one of the cross bars is positioned on a rear portion of the second base section.

In some aspects, the techniques described herein relate to a vehicle sleeping system, further including a sunroof panel configured to extend and retract between a fully closed position in which a sunroof opening is covered and a plurality of open positions in which at least a portion of the sunroof opening is uncovered, wherein the base portion includes an opening that extends through the second base section, the opening sized to correspond to the uncovered portion of the sunroof opening.

In some aspects, the techniques described herein relate to a vehicle sleeping system, further including a seal component positioned around an inner perimeter of the opening, wherein the seal component extends from the opening between the second cross bar and the third cross bar.

In some aspects, the techniques described herein relate to a vehicle sleeping system, further including a clamping mechanism provided on each end of the cross bars, the clamping mechanism configured to secure the cross bars to the mounting system.

In some aspects, the techniques described herein relate to a vehicle sleeping system, further including a cover portion of the sleeping platform, wherein the cover portion is attached to and extends across a second side of the first base section and the second base section.

In some aspects, the techniques described herein relate to a vehicle sleeping system, wherein, when in the folded position, the first base section is folded against the second base section, and the cover portion is sandwiched between the first base section and the second base section.

In some aspects, the techniques described herein relate to a vehicle sleeping system, wherein, when in the unfolded position, the first base section extends outward away from the second base section over the vehicle hood, and an end of each support leg is releasably attachable to one of the attachment points to hold the first base section over the vehicle hood.

In some aspects, the techniques described herein relate to a vehicle sleeping system, including: a vehicle roof panel; a mounting system secured to the vehicle roof panel; and a sleeping platform supported on the mounting system, the sleeping platform including a base portion having a first base section and a second base section that is pivotably attached to the first base section, the sleeping platform moveable between a folded position in which the first base section is folded against the second base section and an unfolded position in which the first base section extends outward away from the second base section over a vehicle hood.

In some aspects, the techniques described herein relate to a vehicle sleeping system, further including support legs of the sleeping platform, the support legs each including a first end and an opposite second end, the first end pivotably attached to a first side of the first base section at a first location, the second end releasably attached to the first side of the first base section at a second location.

In some aspects, the techniques described herein relate to a vehicle sleeping system, wherein the support legs are configured to attach to attachment points on the vehicle hood when in the unfolded position.

In some aspects, the techniques described herein relate to a vehicle sleeping system, wherein, when in the unfolded position, the second end of each support leg is releasably attachable to one of the attachment points to hold first base section over the vehicle hood.

In some aspects, the techniques described herein relate to a vehicle sleeping system, further including a cover portion of the sleeping platform, wherein the cover portion is attached to and extends across the first base section and the second base section.

In some aspects, the techniques described herein relate to a vehicle sleeping system, wherein, when in the folded position, the cover portion is sandwiched between the first base section and the second base section.

In some aspects, the techniques described herein relate to a vehicle sleeping system, wherein, when in the unfolded position, the cover portion is expanded outward by cover frame bars.

In some aspects, the techniques described herein relate to a vehicle sleeping system, further including a sunroof panel configured to extend and retract between a fully closed position in which a sunroof opening is covered and a plurality of open positions in which at least a portion of the sunroof opening is uncovered, wherein the base portion includes an opening that extends through the second base section, the opening sized to correspond to the uncovered portion of the sunroof opening.

In some aspects, the techniques described herein relate to a vehicle sleeping system, wherein the opening is configured to allow access to the sleeping platform from within a passenger compartment of a vehicle.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an exemplary vehicle.

FIG. 2 illustrates an exemplary sleeping platform arranged within the vehicle of FIG. 1, with the sleeping platform in a default configuration.

FIG. 3 illustrates another view of the sleeping platform of FIG. 2 in a first deployed configuration.

FIG. 4 illustrates the sleeping platform of FIG. 2 in a second deployed configuration.

FIG. 5 illustrates the sleeping platform of FIG. 2 in a hybrid configuration.

FIG. 6 illustrates a support assembly arranged on a front seat of the vehicle of FIG. 1, with the support assembly in a stowed position.

FIGS. 7 and 8 shows the support assembly of FIG. 6 in a deployed or unlocked position.

FIG. 9 shows the support assembly of FIG. 6 in a locked position.

FIG. 10 shows a mattress supported on the sleeping platform when the sleeping platform is in the second deployed configuration.

FIG. 11 shows the mattress of FIG. 10 including heating elements.

FIG. 12 illustrates a deployable table arranged on a front seat of the vehicle of FIG. 1, with the deployable table in a stowed position.

FIG. 13 shows the deployable table of FIG. 12 in a deployed position.

FIG. 14 illustrates a storage shelf arranged in a rear storage area of the vehicle of FIG. 1.

FIG. 15 illustrates a sunroof panel of the vehicle of FIG. 1 in an open position.

FIG. 16 illustrates another exemplary sleeping platform arranged within the vehicle of FIG. 1, with the sleeping platform in a first deployed configuration.

FIG. 17 is another view of the sleeping platform of FIG. 16 in a second deployed configuration.

FIG. 18 is a perspective view of a panel segment of the sleeping platform of FIG. 16.

FIGS. 19-24 illustrate a method of moving the sleeping platform of FIG. from a default configuration to the first deployed configuration, and then to the second deployed configuration.

FIG. 25 shows a front panel segment of the sleeping platform of FIG. 16 that is removably attachable to an intermediate panel segment of the sleeping platform.

FIG. 26 is a perspective view of the front panel segment of FIG. 25.

FIG. 27 is another perspective view of the front panel segment of FIG. 25.

FIG. 28 illustrates another exemplary sleeping platform supported on a roof panel of the vehicle of FIG. 1, with the sleeping platform in a folded position.

FIG. 29 is a perspective view of the sleeping platform of FIG. 28 in the folded position.

FIG. 30 shows the sleeping platform of FIG. 28 in an unfolded position.

FIGS. 31 and 32 illustrate a method installing the sleeping platform of FIG. 28 on the vehicle.

FIGS. 33-36 illustrate a method of moving the sleeping platform of FIG. from the folded position to the unfolded position.

FIG. 37 shows the vehicle of FIG. 1 including multiple sleeping platforms.

FIG. 38 illustrates the sleeping platform of FIG. 28 without a cover portion.

FIG. 39 illustrates another exemplary sleeping platform supported on a roof panel of the vehicle of FIG. 1, with the sleeping platform in a folded position.

FIG. 40 is a perspective view of the sleeping platform of FIG. 39 in the folded position.

FIG. 41 shows the sleeping platform of FIG. 39 in an unfolded position.

FIGS. 42-45 illustrate a method of moving the sleeping platform of FIG. 39 from the folded position to the unfolded position.

FIG. 46 shows a base portion of the sleeping platform of FIG. 39 with a built-in inflatable mattress, the inflatable mattress including a first mattress portion that is pivoted upward relative to a second mattress portion.

FIG. 47 shows the inflatable mattress of FIG. 46 with the first mattress portion pivoted downward relative to the second mattress portion.

FIG. 48 is another view of the inflatable mattress of FIG. 46.

FIG. 49 illustrates yet another exemplary sleeping platform supported on a roof panel of the vehicle of FIG. 1, with the sleeping platform in a collapsed position.

FIG. 50 shows the sleeping platform of FIG. 49 in an expanded position.

### DETAILED DESCRIPTION

This disclosure details sleeping platforms for vehicles. For example, a sleeping platform may include a panel segment that is moveable between a folded position and an unfolded position, and a support assembly that is configured to hold the panel segment when in the unfolded position. These and other features are discussed in greater detail in the following paragraphs of this detailed description. Additionally, each of the various embodiments described below describe a situation where the vehicle is stationary and locked from moving, such as in parked mode.

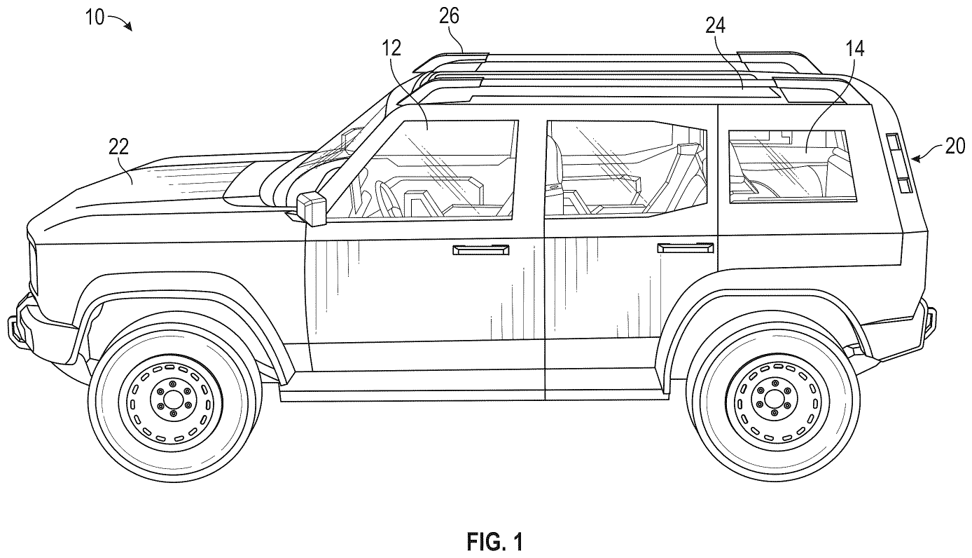

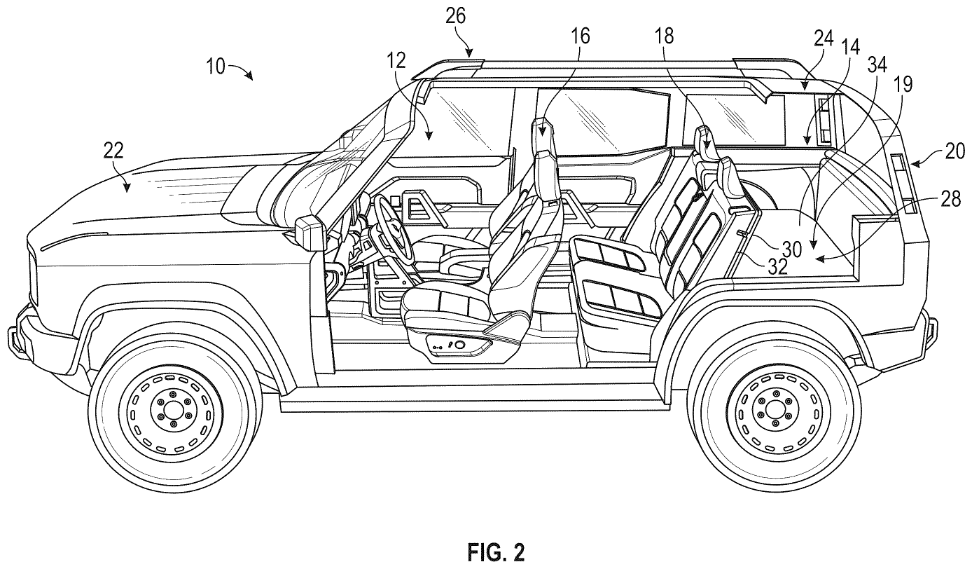

FIGS. 1 and 2 schematically illustrates a motor vehicle 10 (hereinafter referred to simply as “the vehicle”). The vehicle 10 could be a sport utility vehicle, a pickup truck, a car, a van, or any other type of vehicle. Additionally, the vehicle 10 could be a conventional, internal combustion engine powered vehicle, a hybrid or plug-in hybrid vehicle, a battery electric vehicle, an autonomous vehicle (i.e., a driverless vehicle), etc.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component or system.

The vehicle 10 may include a passenger compartment 12 and a rear storage area 14. The passenger compartment 12 may include a row of front seats 16 for accommodating a driver and a passenger, and a row of rear seats 18 for accommodating additional passengers. The front seats 16 and the rear seats 18 may be folded down to align with a floor 19 of the rear storage area 14. In an embodiment, the rear seats 18 may be divided into two sections (e.g., a 60/40 split arrangement) such that one section can remain upright to accommodate passengers while the other section can be folded down to expand the rear storage area 14.

The rear storage area 14 may provide a space for storing cargo (e.g., luggage, etc.). A liftgate 20 or other closure member at the rear of the vehicle 10 may be movable between a closed position and an open position to provide access to the rear storage area 14. At the front of the vehicle 10, a hood 22 may be movable between a closed position and an open position to provide access to a compartment of the vehicle 10, such as an engine compartment or a frunk, for example.

The vehicle 10 may include various panels, including but not limited to, a roof panel 24. A mounting system 26 may be secured to the roof panel 24. In this embodiment, the mounting system 26 is a rack or rail. The mounting system 26 can be used to support or otherwise carry equipment above the roof panel 24. The equipment can include a sleeping platform, kayak, canoe, ladder, surfboard, bicycle, toolbox, storage box, etc.

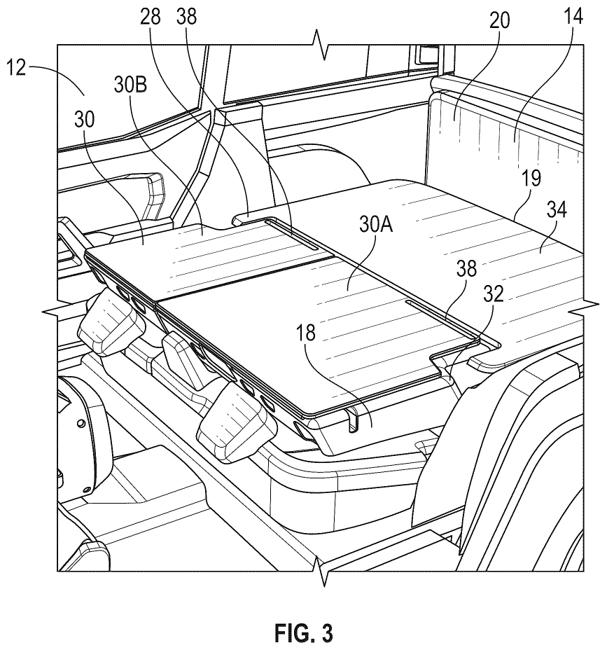

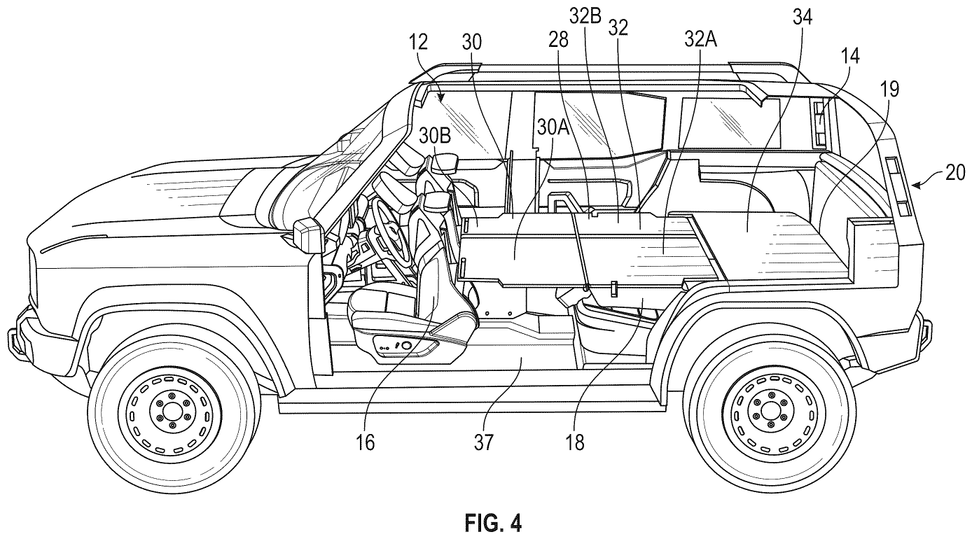

FIGS. 2-4 illustrate additional details associated with the vehicle 10 of FIG. 1. A sleeping platform 28 may be arranged within an interior of the vehicle 10. The sleeping platform 28 may be a foldable panel assembly which may include a front panel segment 30, an intermediate panel segment 32, and a rear panel segment 34 that are pivotably attached to one another such that the sleeping platform 28 may be adaptable to move between a default configuration (FIG. 2), a first deployed configuration (FIG. 3), and a second deployed configuration (FIG. 4). The front panel segment 30 may be pivotably attached to the intermediate panel segment 32 at a first location to allow the front panel segment 30 to move between a folded position (FIGS. 2 and 3) to an unfolded position (FIG. 4). The front panel segment 30 may also be releasably attached to the intermediate panel segment 32 at a second location to hold the front panel segment 30 in the folded position. The intermediate panel segment 32 may be attached to and span across the rear surface of the rear seats 18. The rear panel segment 34 may be attached to and span across the floor 19 of the rear storage area 14.

When in the default configuration, the rear seats 18 are upright. The front panel segment 30 may be held in the folded position against the intermediate panel segment 32. The front panel segment 30 and the intermediate panel segment 32 may form a backwall of the rear storage area 14, and the rear panel segment 34 may form a floor of the rear storage area 14.

Pivoting the rear seats 18 downward moves the sleeping platform 28 into the first deployed configuration. The intermediate panel segment 32 and thus also the front panel segment 30 may be pivoted downward with the rear seats 18 such that the front panel segment 30 and the intermediate panel segment 32 are substantially planar with the rear panel segment 34.

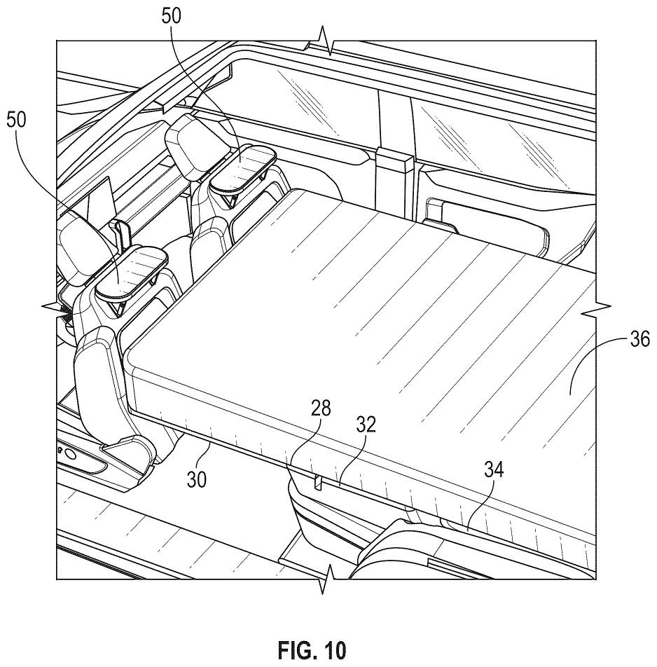

To move the sleeping platform 28 into the second deployed configuration, the front panel segment 30 may be pivoted from the folded position to the unfolded position. Before moving the front panel segment 30 to the unfolded position, the front seats 16 may be moved forward to provide more space to accommodate the front panel segment 30. The front panel segment 30 may then be detached from the intermediate panel segment 32 at the second location so that the front panel segment 30 can pivot outward at the first location from the intermediate panel segment 32 to the unfolded position. In the unfolded position, the front panel segment 30 is substantially planar with the intermediate panel segment 32 and the rear panel segment 34, which provides a level platform to support a mattress 36 (see FIG. 10), for example. As shown in FIG. 4, a space 37 may be provided between the front panel segment 30 and the floor of the passenger compartment 12 to accommodate cargo (e.g., luggage) when the sleeping platform 28 is in the second deployed configuration.

Referring to FIGS. 3-5, the front panel segment 30 may be divided into a first panel section 30A and a second panel section 30B. The first panel section 30A and the second panel section 30B may each pivot independently relative to the intermediate panel segment 32 between the folded position and the unfolded position. As discussed further below, the first panel section 30A and the second panel section 30B may each include a slot 38 (FIG. 3) for securing the sleeping platform 28 to the front seats 16 when the sleeping platform 28 is in the second deployed configuration.

The intermediate panel segment 32 may be similarly divided into a first panel section 32A and a second panel section 32B. The first panel section 32A and the second panel section 32B may each pivot independently with corresponding sections of the rear seats 18 between an upright position and a horizontal position.

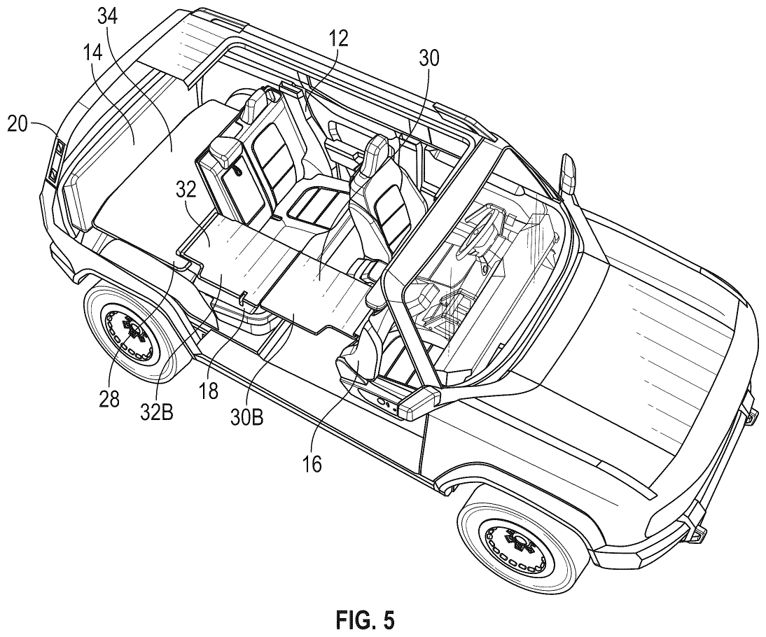

As shown in FIG. 5, with the front panel segment 30 and the intermediate panel segment 32 divided into respective first and second panel sections, the sleeping platform 28 may be positioned in a hybrid configuration in which a partial section of the sleeping platform 28 may be used to support a mattress. In this embodiment, the first panel section 32A of the intermediate panel segment 32 and the first panel section 30A of the front panel segment 30 may be held upright by a corresponding first section of the rear seats 18. To move the sleeping platform 28 into the hybrid configuration, the second panel section 30B of the front panel segment 30 is moved to the unfolded position. Before moving the second panel section 30B to the unfolded position, one of the front seats 16 (here the passenger seat) may be moved forward to provide more space to accommodate the second panel section 30B. The second panel section 32B of the intermediate panel segment 32 and thus also the second panel section 30B of the front panel segment 30 may then be pivoted downward with a corresponding second section of the rear seats 18. The second panel section 30B may then be pivoted outward to align with the horizontal plane of the second panel section 32B and the rear panel segment 34, thereby creating a level platform for supporting a mattress (i.e., the second panel section 30B is substantially planar with the second panel section 32B and the rear panel segment 34). In contrast to the second deployed configuration (FIG. 4), one section of the sleeping platform 28 may function as a bed without adjusting one of the front seats 16 (here the driver seat) via the hybrid configuration.

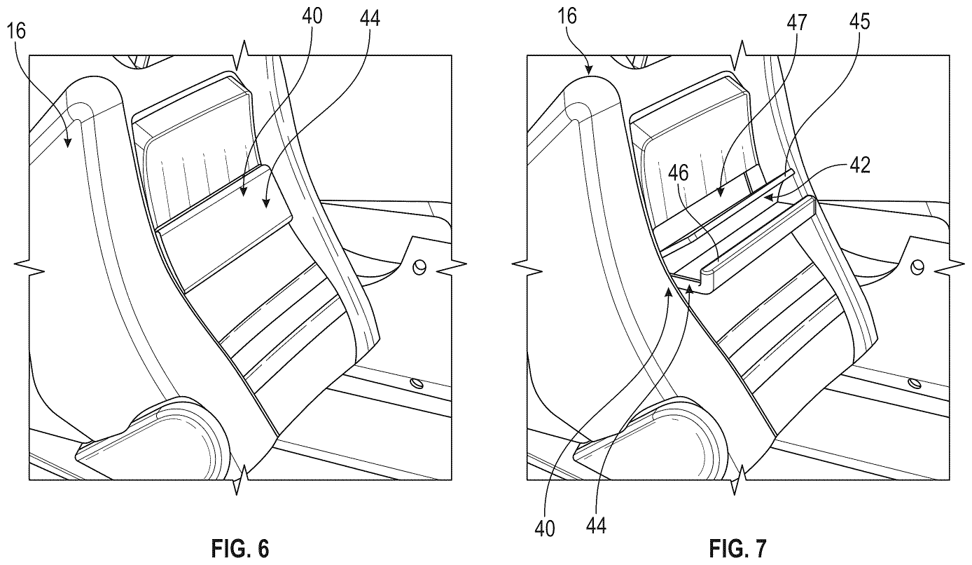

Referring now to FIGS. 6-9, a support assembly 40 may be provided on the rear of each of the front seats 16 to secure the front panel segment 30 to the front seats 16 when the sleeping platform 28 is positioned in the second deployed configuration. The support assembly 40 may include a first arm 42 and a second arm 44 that are each pivotably attached at a first location to an internal structural frame of each of the front seats 16. The first arm 42 may include an end portion 45 that may be configured to lockingly engage an end portion 46 of the second arm 44 to lock the support assembly 40 in place for supporting the front panel segment 30. In an embodiment, one of the end portions 45, 46 may include a feature (e.g., a notch, recess, or hook) that aligns with and engages a matching feature (e.g., a protrusion, notch, or groove) of the other one of the end portions 45, 46.

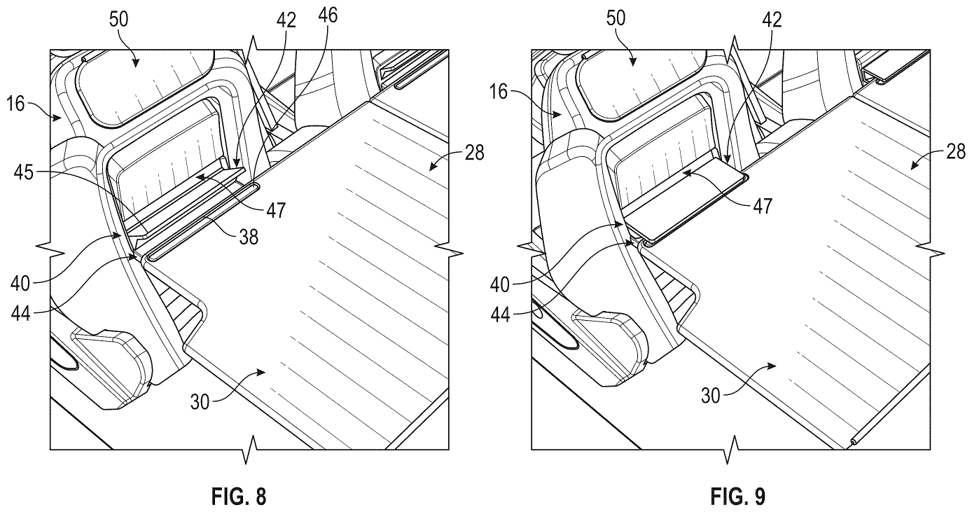

The support assembly 40 may be configured to pivot between a stowed position (FIG. 6), a deployed or unlocked position (FIGS. 7 and 8), and a locked position (FIG. 9).

When in the stowed position, the support assembly 40 may be folded against the rear of the front seats 16. The second arm 44 may at least partially enclose the first arm 42 within a pocket 47 formed in the front seats 16. The first arm 42 and the second arm 44 are substantially planar with the front seats 16 in this position.

When in the deployed or unlocked position, the support assembly 40 may extend outwardly from the front seat 16. The first arm 42 may extend outward from the front seat 16 at an angle above the second arm 44. The second arm 44 may extend transversely from the front seat 16. Once the support assembly 40 is in the deployed or unlocked position, the front panel segment 30 of the sleeping platform 28 may be pivoted from the folded position to the unfolded position (FIG. 8). The end portion 46 of the second arms 44 may extend through the slots 38 of the front panel segment 30 to hold the front panel segment 30 in place on the second arm 44.

To move the support assembly 40 to the locked position shown in FIG. 9, the first arm 42 may be pivoted downward so that the end portion 45 of the first arm 42 can align with and engage the end portion 46 of the second arm 44. When the end portions 45, 46 are engaged, the support assembly 40 functions to hold the front panel segment 30 in the unfolded position.

With further reference to FIG. 10, the mattress 36 may be arranged on the sleeping platform 28 once the front panel segment 30 is unfolded and held in place by the support assembly 40. In an embodiment, the mattress 36 is an inflatable mattress. However, any type of mattress could be utilized in combination of the sleeping platform 28.

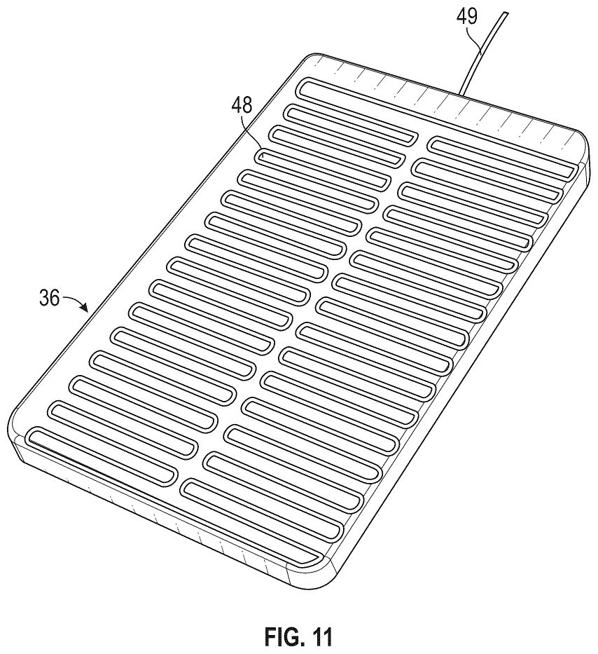

In the embodiment of FIG. 11, the mattress 36 may include internal heating elements 48 (e.g., heating wires or coils) to provide a heated mattress. A cable or wire 49 may extend from the mattress 36 and may be plugged into a power supply (e.g., an electrical outlet) to power the internal heating elements 48. The heated mattress can work in combination with the HVAC (Heating, Ventilation, and Air Conditioning) system of the vehicle 10 to enhance user comfort within the passenger compartment 12.

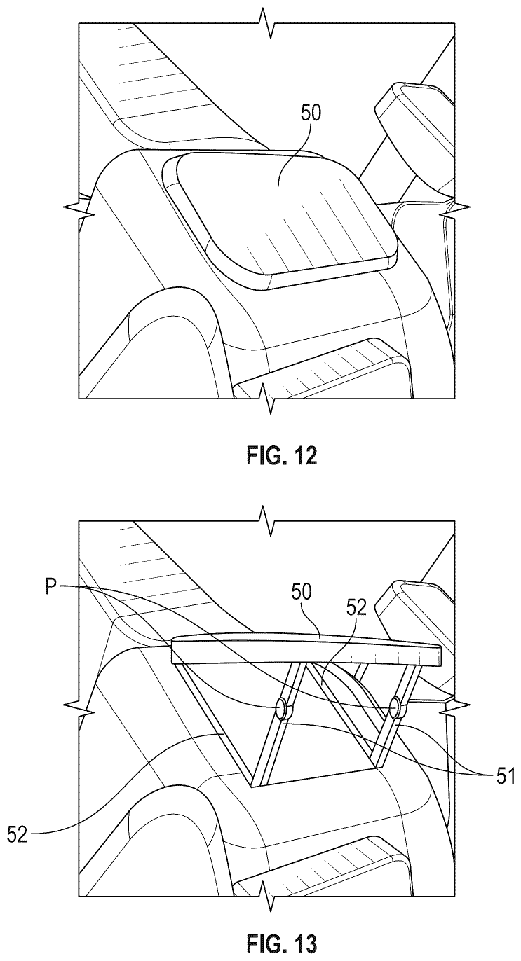

Referring to FIGS. 12 and 13, a deployable table 50 may be attached to the rear of each of the front seats 16 at a position that is vertically above the support assembly 40. The deployable table 50 may be attached at a first location via a pivot mechanism that allows the deployable table 50 to pivot between a stowed position (FIG. 12) and a deployed position (FIG. 13). A pair of pivotable legs 51 attach the deployable table 50 at a second location to provide stability when the deployable table 50 is in the deployed position. Each of the pivotable legs 51 may include a pivot point P for allowing the pivotable legs 51 to be folded and unfolded relative to corresponding recessed channels 52 integrated into the front seat 16.

When in the stowed position, the deployable table 50 may be substantially planar with the front seat 16 with the pivotable legs 51 received within the corresponding recessed channels 52. When in the deployed position, the pivotable legs 51 may be unfolded to extend from the recessed channels 52 and locked in place to hold the deployable table 50 at an angle relative to the front seat 16. The deployable table 50 may provide a stable surface for holding items, such as phones, tablets, snacks, drinks, etc. when utilizing the sleeping platform 28.

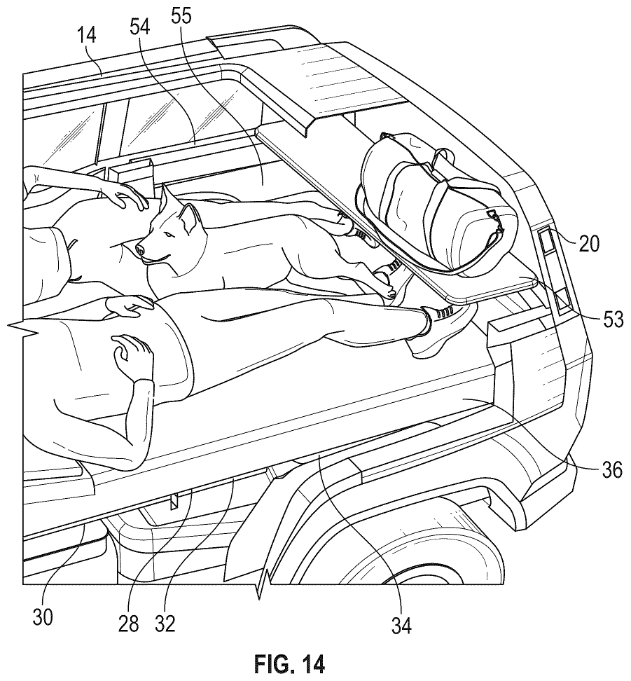

With reference to FIG. 14, the rear storage area 14 of the vehicle 10 may include a storage shelf 53. The storage shelf 53 may be mounted on a ridge 54 that extends along opposed sidewalls 55 of the rear storage area 14 and the liftgate 20. In an embodiment, each ridge 54 could include recesses or notches that correspond to matching tabs or pegs on the underside of the storage shelf 53 to align and secure the storage shelf 53 to the ridge 54. Cargo such as luggage or other items may be supported on the storage shelf 53.

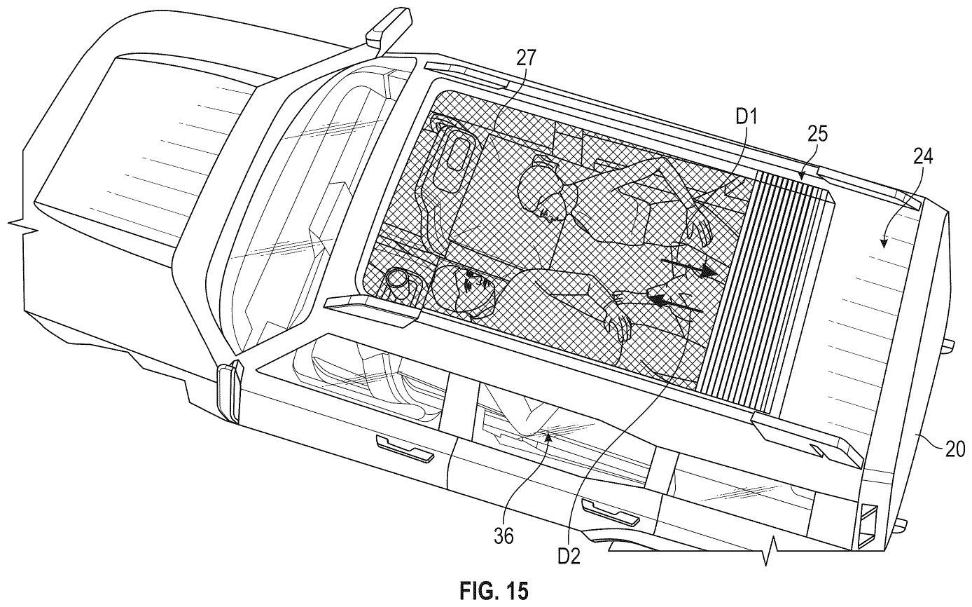

Referring now to FIG. 15, the roof panel 24 may include a roof opening that may be selectively covered and uncovered by a sunroof panel 25. The sunroof panel 25 may be made of a flexible, waterproof material, such as canvas, leather, etc. The sunroof panel 25 is sized and shaped to correspond to a size and shape of the roof opening, such that the sunroof panel 25 can fully cover the roof opening.

The sunroof panel 25 may be configured to extend and retract from either of its opposed ends between a fully closed position and a plurality of open positions. In an embodiment, the sunroof panel 25 may be manually moved between the fully closed position and the plurality of open positions without powered electric components, such as motors, drives, actuators, etc. In a particular embodiment, the sunroof panel 25 may be manually moved by hand without the use of tools such as screwdrivers, drills, wrenches, etc.

The sunroof panel 25 may be moved in a first direction D1 from the fully closed position to a first open position. The first direction D1 may be a rearward direction. Once the sunroof panel 25 is in the first open position, a portion of the sunroof opening to a side of the sunroof panel 25 is uncovered by the sunroof panel 25. In this embodiment, a forwardmost portion of the passenger compartment 12 is uncovered when the sunroof panel 25 is in the first open position. Although this embodiment is directed to the sunroof panel 25 being moved in the first direction D1, it should be understood that the sunroof panel 25 could additionally or alternatively be moved in an opposite second direction D2 to uncover a rear portion of the passenger compartment 12.

A net 27 may span across the sunroof opening below the sunroof panel 25. The net 27 may provide protection from insects, for example, when the sunroof panel 25 is open. The net 27 may be made of a durable, lightweight material having a mesh that blocks small insects from entering the vehicle 10 while allowing air to flow freely into and out of the vehicle 10. The net 27 may be configured to match the dimensions of the sunroof opening to ensure complete coverage without sagging.

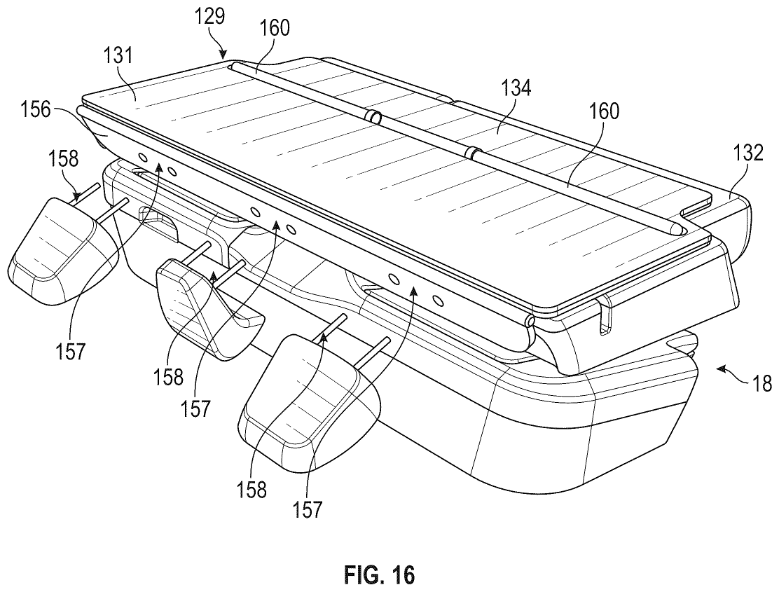

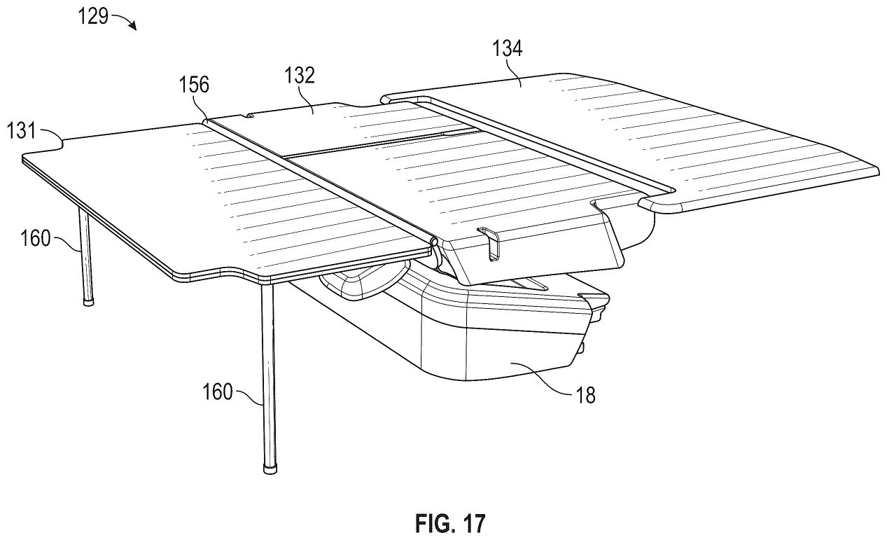

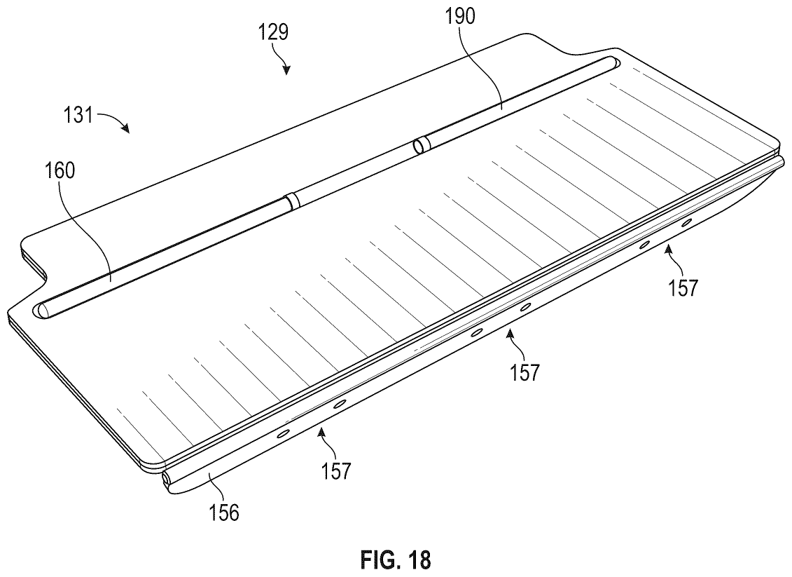

FIGS. 16-19 illustrates another exemplary sleeping platform 129 arranged within an interior of the vehicle 10. The sleeping platform 129 may be a foldable panel assembly which may include a front panel segment 131, an intermediate panel segment 132, and a rear panel segment 134. The sleeping platform 129 may be adaptable to move between a default position discussed above with respect to FIG. 2), a first deployed configuration (FIG. 16) and a second deployed configuration (FIG. 17) by pivoting the front panel segment 131, the intermediate panel segment 132, and the rear panel segment 134 relative to one another.

The sleeping platform 129 may be a modular sleeping platform. The front panel segment 131 may include a piano hinge section 156 that is removably attached to the rear seats 18 at a first location. The piano hinge section 156 may include a plurality of openings 157 spaced across the length of the piano hinge section 156 in groups of two openings. The openings 157 may be aligned with corresponding openings in the rear seats 18 so that headrest posts 158 may be inserted therethrough, and thereby attach the front panel segment 131 to the rear seats 18 at the first location. The piano hinge section 156 allows the front panel segment 131 to pivot relative to the intermediate panel segment 132 between a folded position (FIG. 16) and an unfolded position (FIG. 17). The front panel segment 131 may also be releasably attached to the intermediate panel segment 132 at an opposite second location to hold the front panel segment 131 in the folded position.

A pair of support legs 160 may be arranged on a side of the front panel segment 131 that faces upward when the front panel segment 131 is in the folded position, and faces downward when the front panel segment 131 is in the unfolded position. In an embodiment, one of the support legs 160 is positioned on one end of the front panel segment 131, and the other one of the support legs 160 is positioned on a different end of the front panel segment 131. The support legs 160 may be pivotably attached to the front panel segment 131 and may deploy vertically outward into contact with the floor of the passenger compartment 12 when the front panel segment 131 is unfolded. When not in use, the support legs 160 may fold back into a recessed area within the front panel segment 131.

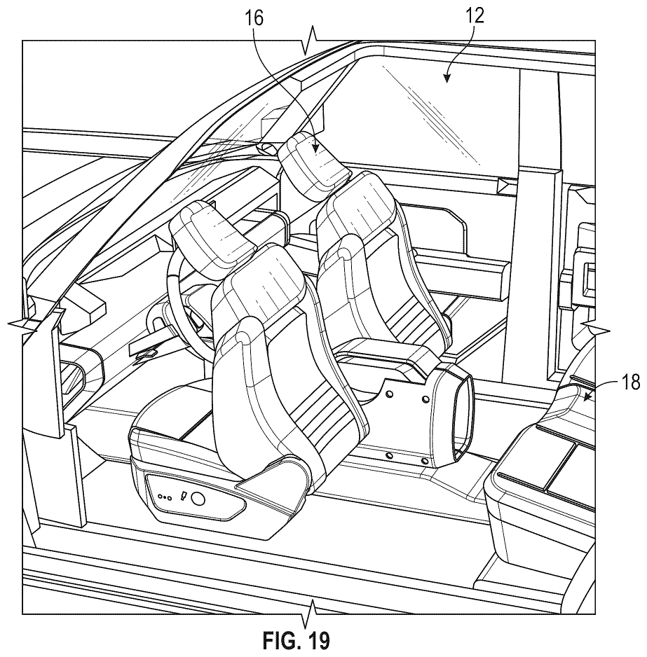

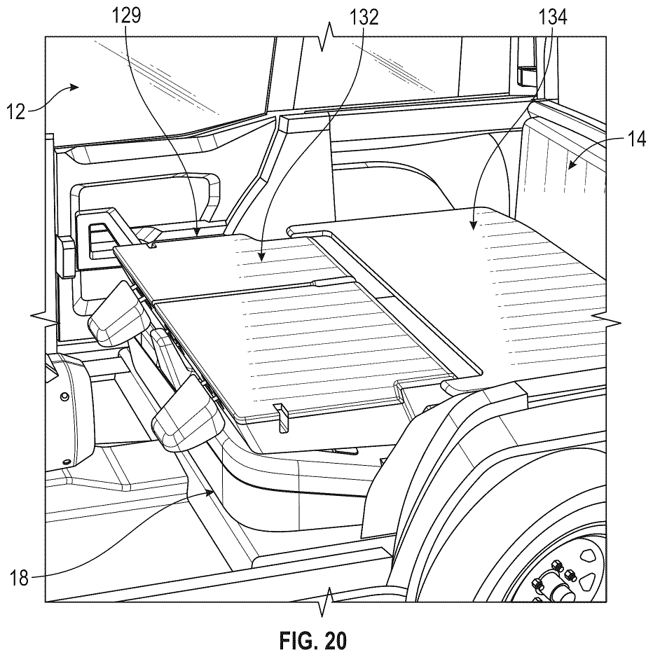

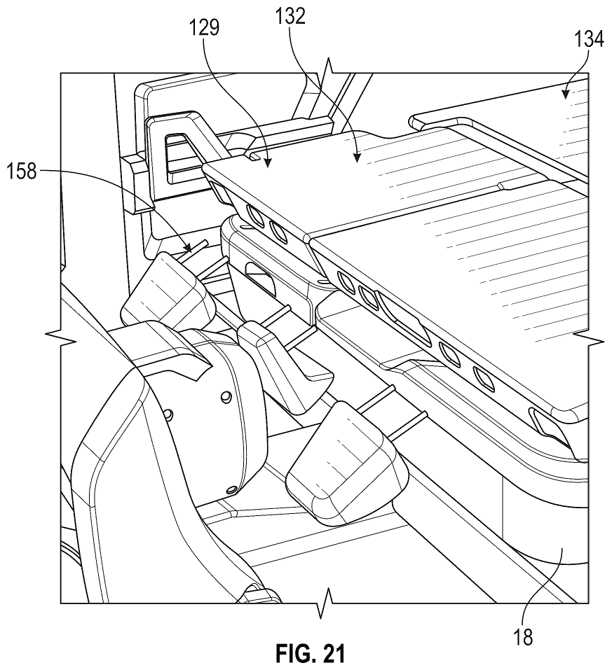

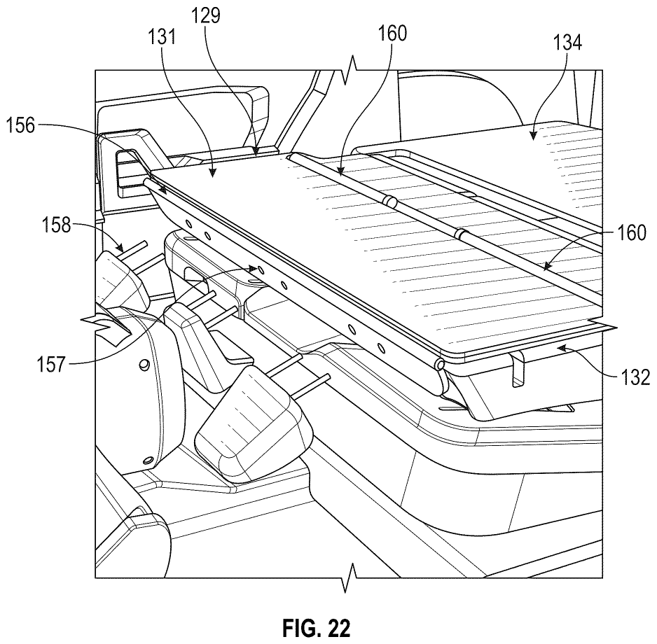

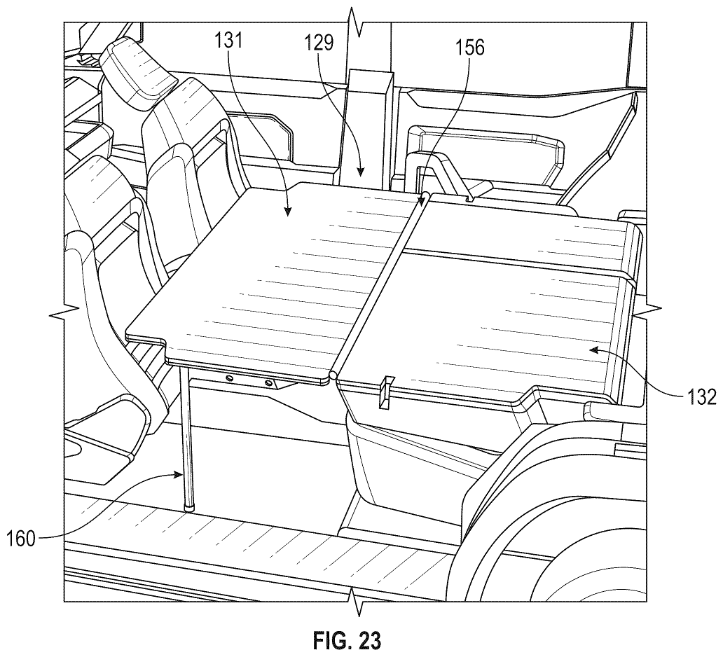

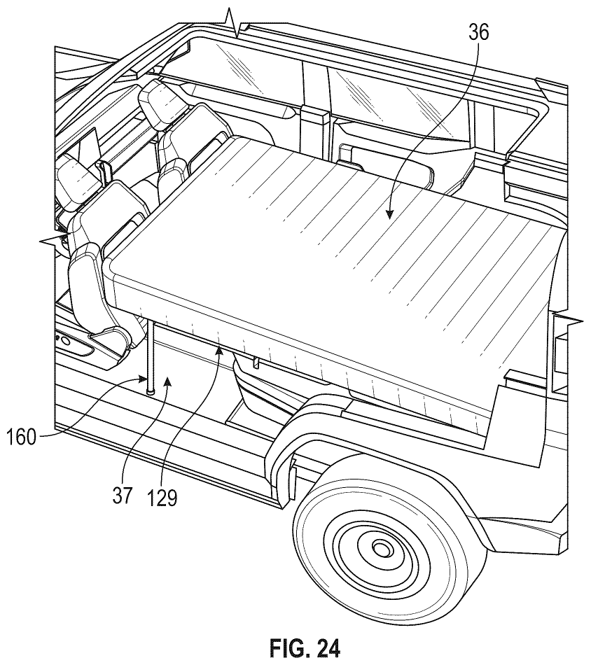

FIGS. 19-24 illustrate an exemplary method of moving the sleeping platform 129 from default configuration to the first deployed configuration, and then to the second deployed configuration. As discussed above with respect to FIG. 2, in the default configuration, the rear seats 18 are upright. The front seats 16 may first be moved forward to provide more space to accommodate the front panel segment 131 (FIG. 19). The rear seats 18 may then be pivoted downward to a horizontal position. Pivoting the rear seats 18 also pivots the intermediate panel segment 132 downward such that the intermediate panel segment 132 is substantially planar with the rear panel segment 134 (FIG. 20). Once the intermediate panel segment 132 and the rear panel segment 134 are aligned, the headrest posts 158 may be removed from the rear seats 18 (FIG. 21). The front panel segment 131 may then be positioned on the intermediate panel segment 132 with the openings 157 of the piano hinge section 156 aligned with the corresponding openings in the rear seats 18 (FIG. 22). The headrest posts 158 may then be inserted through the piano hinge section 156 and the rear seats 18 to attach the front panel segment 131 to the rear seats 118. The front panel segment 131 may then be pivoted from the folded position to the unfolded position, which allows the support legs 160 to pivot vertically outward into contact with the floor 19 of the passenger compartment 12 (FIG. 23). The support legs 160 may support the front panel segment 131 in horizontal alignment with the intermediate panel segment 132 and the rear panel segment 134 to form a level platform for supporting a mattress 36 (FIG. 24). A space 37 may be provided between the front panel segment 131 and the floor of the passenger compartment 12 to accommodate cargo when the sleeping platform 129 is in the second deployed configuration.

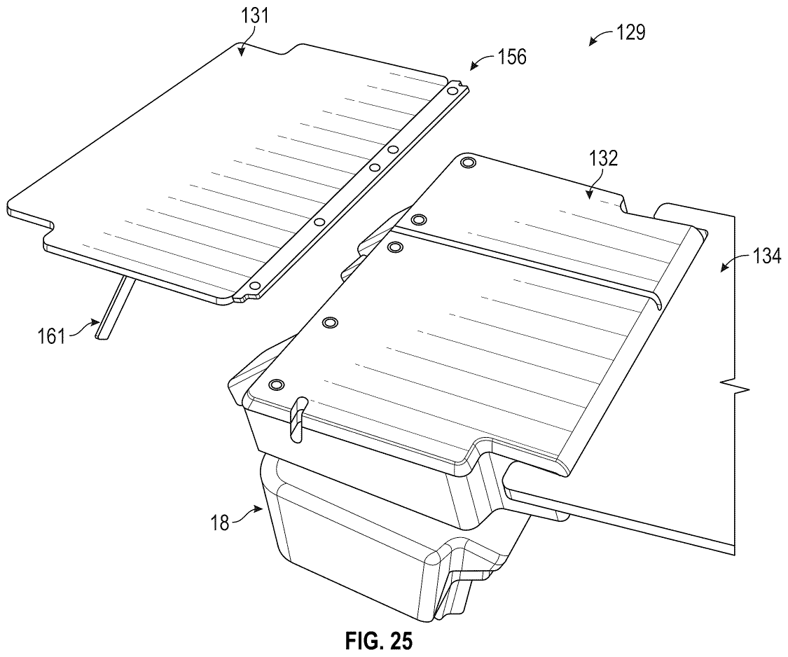

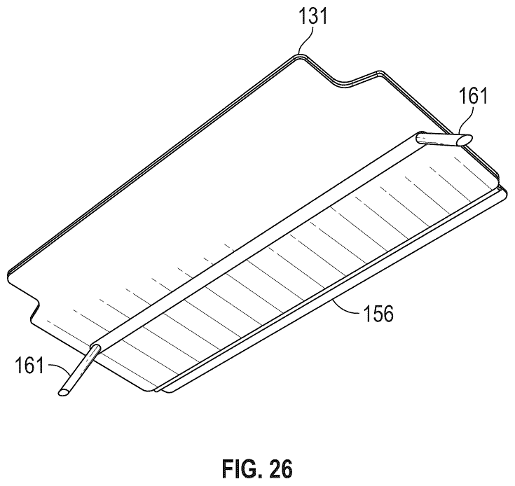

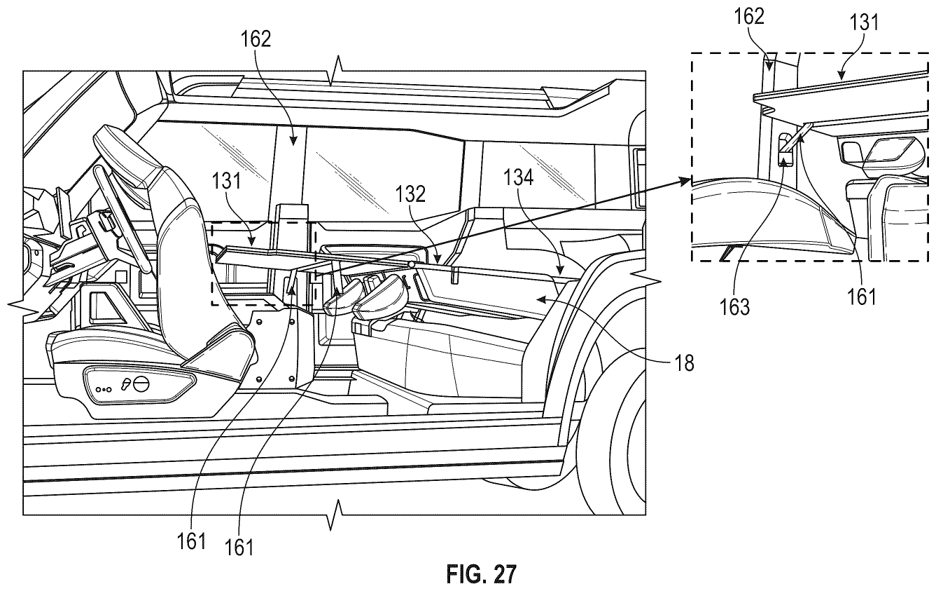

FIGS. 25-27 illustrate another exemplary embodiment of the sleeping platform 129. In this embodiment, the front panel segment 131 may be removably attached to the intermediate panel segment 132 and the rear seats 18 via mechanical fasteners (e.g., bolts). The mechanical fasteners may be inserted through the openings in the piano hinge section 156 and corresponding openings in the intermediate panel segment 132 and the rear seats 18.

The front panel segment 131 may include a pair of support legs 161. The support legs 161 are similar to the support legs 160. However, in this embodiment, the support legs 161 are shorter than the support legs 160 and do not extend to the floor of the passenger compartment 12 when the front panel segment 131 is in the unfolded position. Instead, the support legs 161 may be pivotably attached to the front panel segment 131 and may deploy vertically outward to engage an adjacent pillar 162 of the vehicle 10 when the front panel segment 131 is unfolded. Since the support legs 161 are shorter and do not contact the floor, more space is provided beneath the front panel segment 131 for storing cargo.

In an embodiment, each pillar 162 may include a recessed support structure 163. The recessed support structure 163 is integrally formed within each pillar 162. The recessed support structure 163 may include molded or reinforced surfaces that serve as a base for supporting the support legs 161 and thus also the front panel segment 131 when the sleeping platform 129 is in the second deployed configuration.

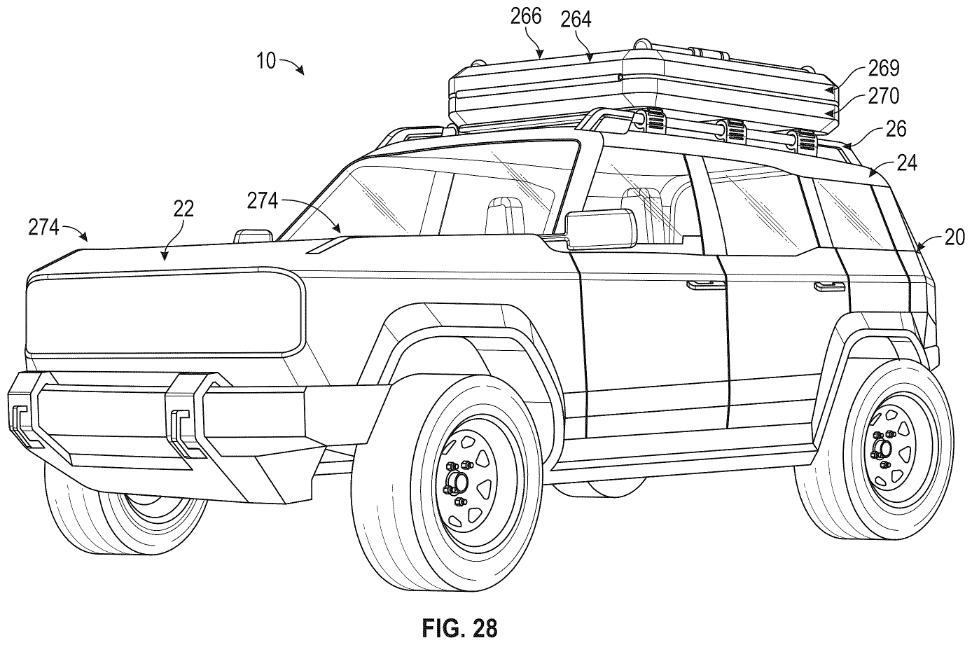

With reference now to FIGS. 28-30, the vehicle 10 may alternatively or additionally include a sleeping platform 264 that can be supported on the roof panel 24 via the mounting system 26. The sleeping platform 264 may include a base portion 266 and a cover portion 268. The base portion 266 may include a first base section 269 and a second base section 270 which may be pivotably attached to one another to allow the sleeping platform 264 to move between different positions, the details of which are discussed further below.

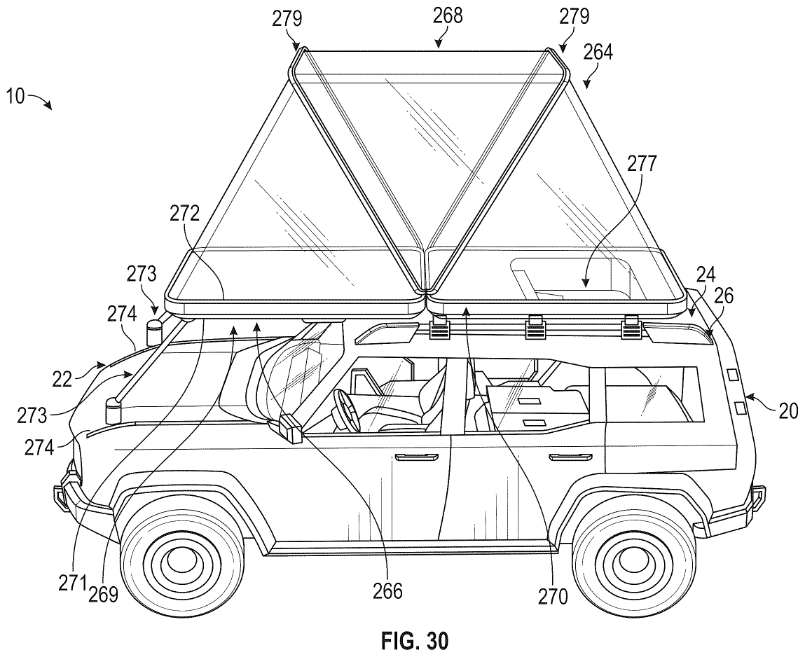

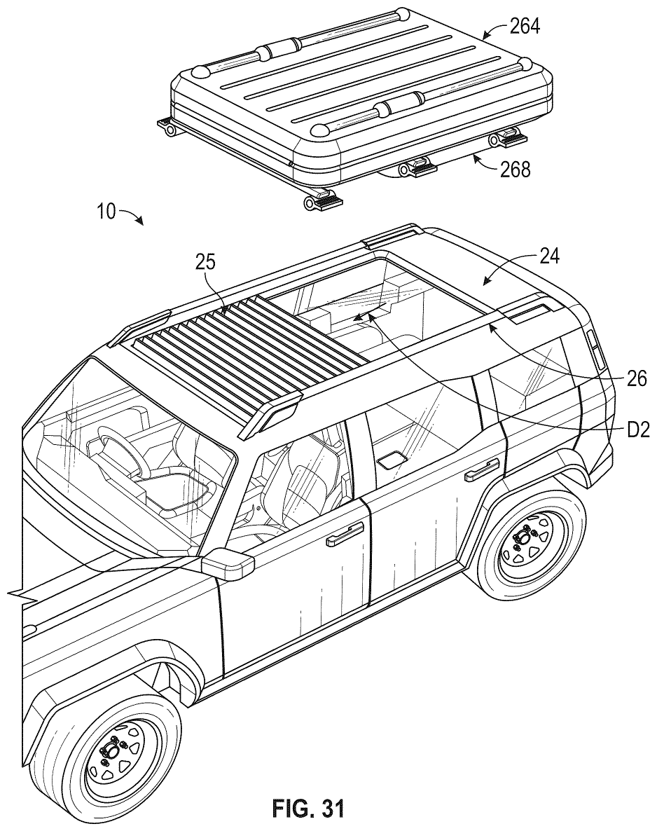

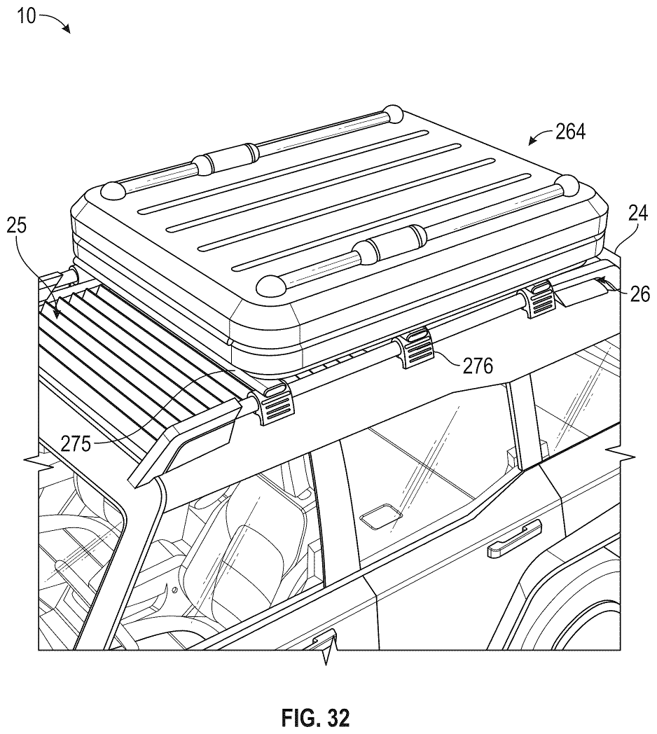

The base portion 266 may include a first side 271 and an opposite second side 272 (shown best in FIG. 30). Support legs 273 may be attached to the first side 271 of the first base section 269. The support legs 273 may each include a first end that is pivotably attached to the first base section 269 at a first location and an opposite second end that is releasably attached to the first base section 269 at a second location. Releasing the support legs 273 at the second end allows the support legs 273 to pivot at the first end relative to the first base section 269. The second end of the support legs 273 may then be releasably attached to attachment points 274 on the hood 22.

The first side 271 of the second base section 270 may be supported on the mounting system 26 by cross bars 275. The cross bars 275 may be attached to and span across the second base section 270 between the rails of the mounting system 26. The cross bars 275 may be spaced apart relative to one another. In this embodiment, one of the cross bars 275 may be positioned on a forward portion of the second base section 270, a different one of the cross bars 275 may be positioned on a middle portion of the second base section 270, and another one of the cross bars 275 may be positioned on a rear portion of the second base section 270. A clamping mechanism 276 may be provided on each end of each cross bar 275. Each clamping mechanism 276 may be used to secure the second base section 270 to the mounting system 26.

The base portion 266 may also include an opening 277 (see FIG. 30) that extends through the second base section 270. The opening 277 may be sized to correspond to the uncovered portion of the sunroof opening when the sunroof panel 25 is in one of the open positions. The opening 277 may be configured to allow a user to access the sleeping platform 264 from the passenger compartment 12.

A seal component 278 may be positioned around an inner perimeter of the opening 277. In this embodiment, the seal component 278 may extend from the opening 277 between the two rearmost cross bars 275 and at least partially into the vehicle 210 through the uncovered portion of the sunroof opening when the sunroof panel 25 is one of the open positions. The seal component 278 may contact an inner perimeter of the uncovered portion of the sunroof opening to form a seal which helps maintain a desired temperature within the sleeping platform 264, such as by preventing heat loss or air infiltration, for example.

The cover portion 268 may be attached to the second side 272 of the base portion 266. The cover portion 268 may extend across the entire length of the base portion 266 (i.e., the cover portion 268 extends across the first base section 269 and the second base section 270). The cover portion 268 may be integrated into the base portion 266. The cover portion 268 may be made of a flexible, waterproof material that acts as a barrier between users and the exterior environment to provide protection from exterior elements, such as wind, rain, snow, and other elements. Additionally, the material of the cover portion 268 could include insulating properties or ultraviolet (UV) resistant properties to maintain a comfortable internal environment within the sleeping platform 264.

The base portion 266 and the cover portion 268 together create a protected and insulated space within the sleeping platform 264. In an embodiment, the HVAC system of the vehicle 10 can be used to enhance user comfort within the sleeping platform 264. For instance, heat and air from the HVAC system may infiltrate the sleeping platform 264 through the opening 277 to help maintain a desired internal environment in the sleeping platform 264.

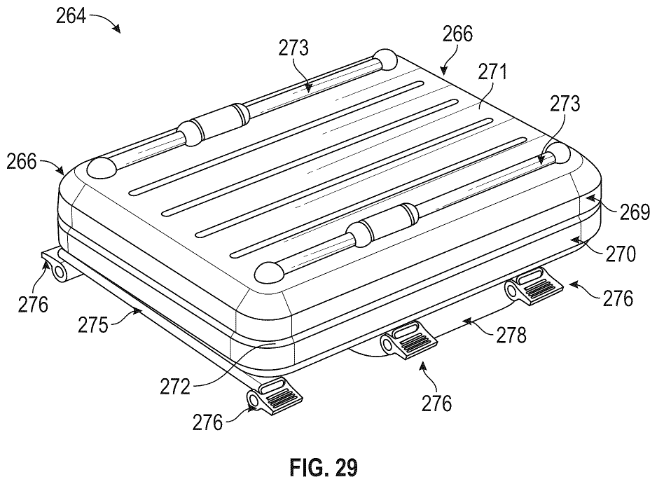

The sleeping platform 264 may be configured to move between a folded position (FIGS. 28 and 29) and an unfolded position (FIG. 30).

In the folded position, the first and second sections 269, 270 of the base portion 266 may be pivoted together to enclose or otherwise sandwich the cover portion 268 therebetween. The sleeping platform 264 is held compactly so that it can be transported from one location to another on the roof panel 24 of the vehicle 10.

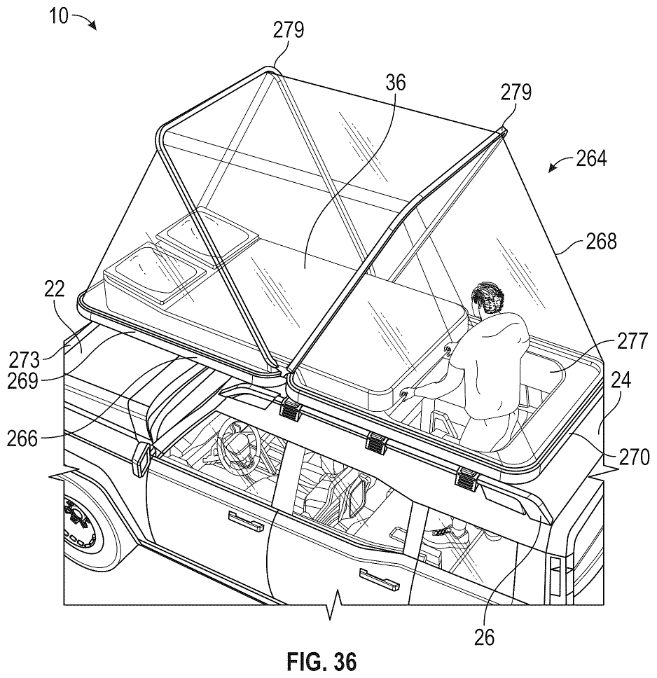

In the unfolded position, the first and second base sections 269, 270 may be horizontally aligned to form a level platform for supporting a mattress 36 (FIG. 36). The support legs 273 on the first base section 269 extend downward and may be attached to the attachment points 274 to support the first base section 269 above the hood 22. The cover portion 268 may be expanded outward in the unfolded position by cover frame bars 279. The cover frame bars 279 may be positioned on either an outer surface or an inner surface of the cover portion 268. The cover frame bars 279 may serve to expand and stabilize the cover portion 268 when the sleeping platform 264 is in the unfolded position.

With reference to FIG. 31, before supporting the sleeping platform 264 on the roof panel 24 of the vehicle 10, the sunroof panel 25 may be moved in the second direction D2 to a second open position. The second direction D2 may be a forward direction. Once the sunroof panel 25 is in the second open position, a portion of the sunroof opening on a side of the sunroof panel 25 opposite the second direction D2 is uncovered by the sunroof panel 25. In this embodiment, a rearmost portion of the passenger compartment 12 is uncovered when the sunroof panel 25 is in the second open position. The second open position may be sized to accommodate the seal component 278 of the sleeping platform 264.

As shown in FIG. 32, the sleeping platform 264, while in the folded position, may then be attached to the mounting system 26 on the roof panel 24. More specifically, the clamping mechanisms 276 on the ends of the cross bars 275 may be attached to the rails of the mounting system 26. The seal component 278 (FIG. 31) may then be deployed from the opening 277 to form a seal between the sleeping platform 264 and the vehicle 10 (FIG. 30).

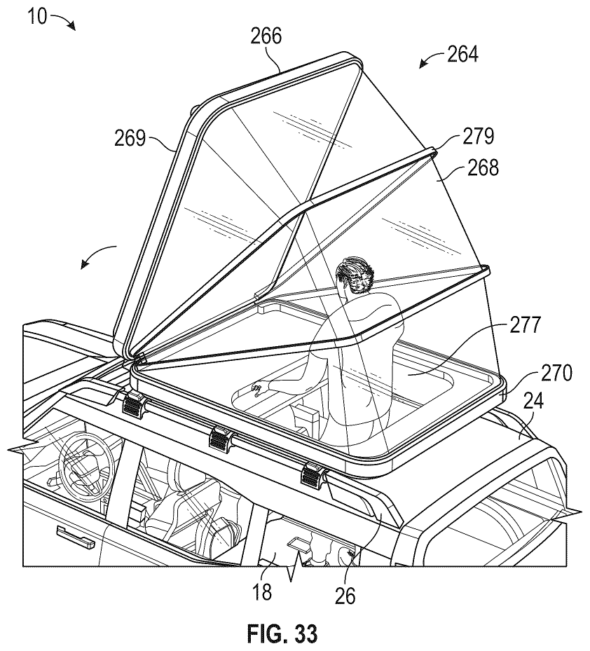

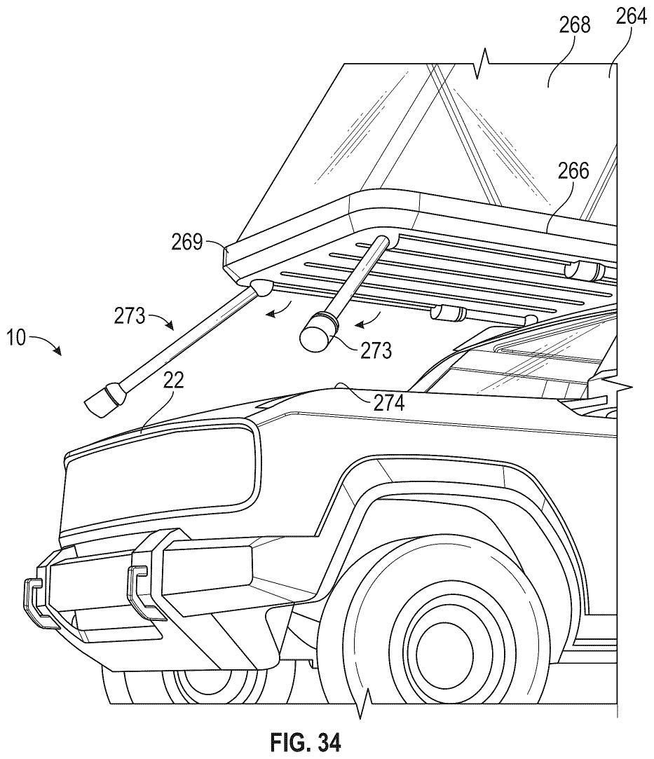

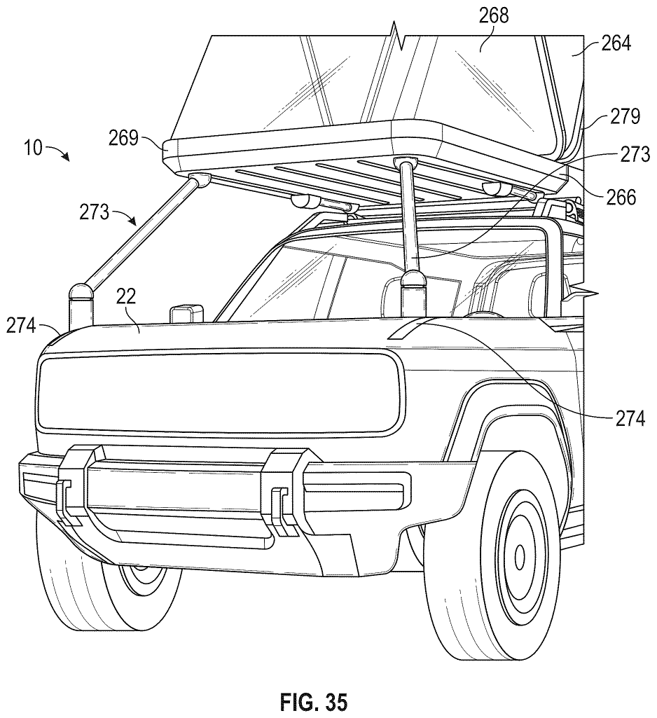

Referring next to FIGS. 33-36, to move the sleeping platform 264 to the unfolded position, a user, while standing on the back of the rear seats 18, for example, may push the first base section 269 outward through the opening 277 in the second base section 270 until the first base section 269 is fully extended and horizontally aligned with the second base section 270. As the sleeping platform 264 unfolds, the cover frame bars 279 expand and stabilize the cover portion 268, and the support legs 273 on the first base section 269 may extend downward for attachment to the attachment points 274 on the hood 22. With the first base section 269 and the second base section 270 horizontally aligned, a mattress 36 may be supported inside the sleeping platform 264 on the base portion 266.

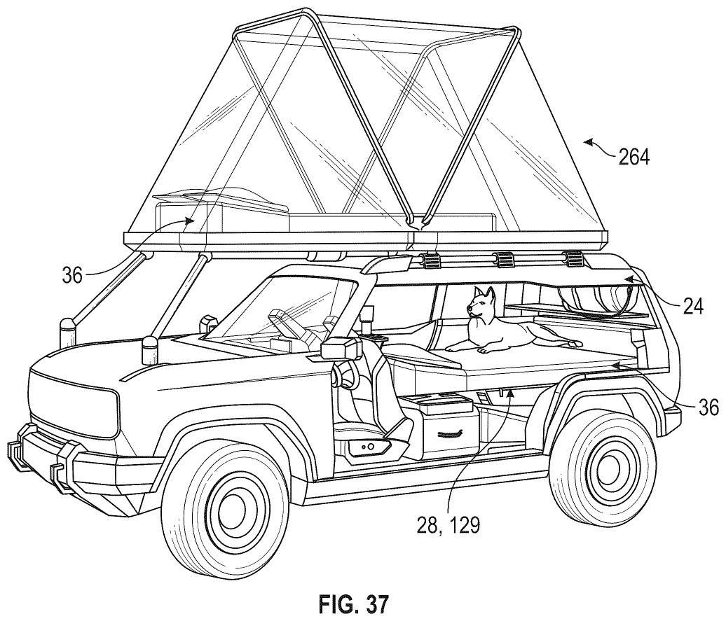

In an embodiment, the sleeping platform 264 may be provided in addition to one of the sleeping platforms 28, 129, discussed above. As shown in FIG. 37, one of the sleeping platforms 28, 129 may be arranged within the interior of the vehicle 10 to support a different mattress 36. In this embodiment, the sleeping platform 28, 129 and the sleeping platform 264 may be vertically separated by the roof panel 24. The vehicle 10 may thus include multiple sleeping platforms, thus allowing for personalized sleeping arrangements where different users may have separate sleeping spaces.

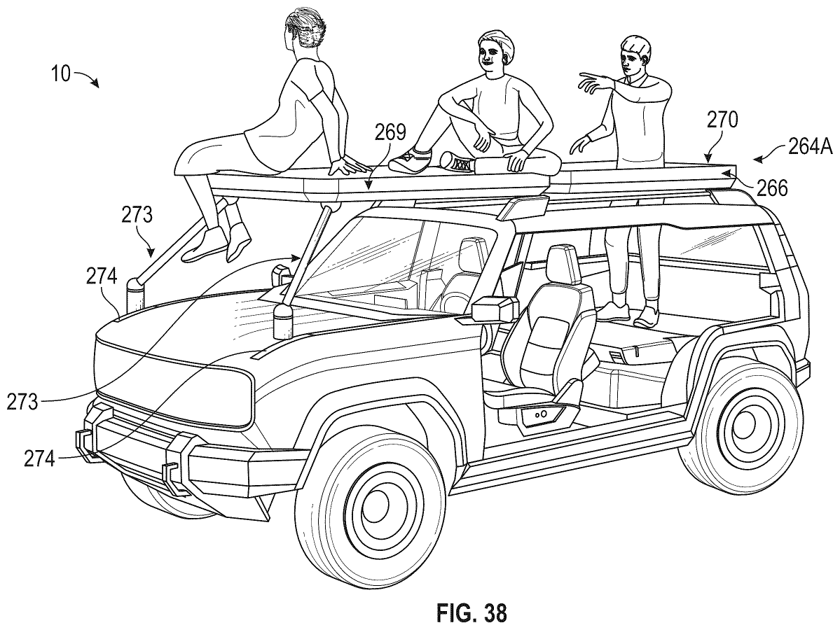

FIG. 38 illustrates another exemplary sleeping platform 264A supported on the vehicle 10. The sleeping platform 264A may be similar to the sleeping platform 264. However, in this embodiment, the platform 264A may include the base portion 266 but without the cover portion 268 and the cover frame bars 279. When in the unfolded position, the sleeping platform 264A may provide a level platform for sitting or laying down, making it particularly suitable for use in situations where a protective cover is not required.

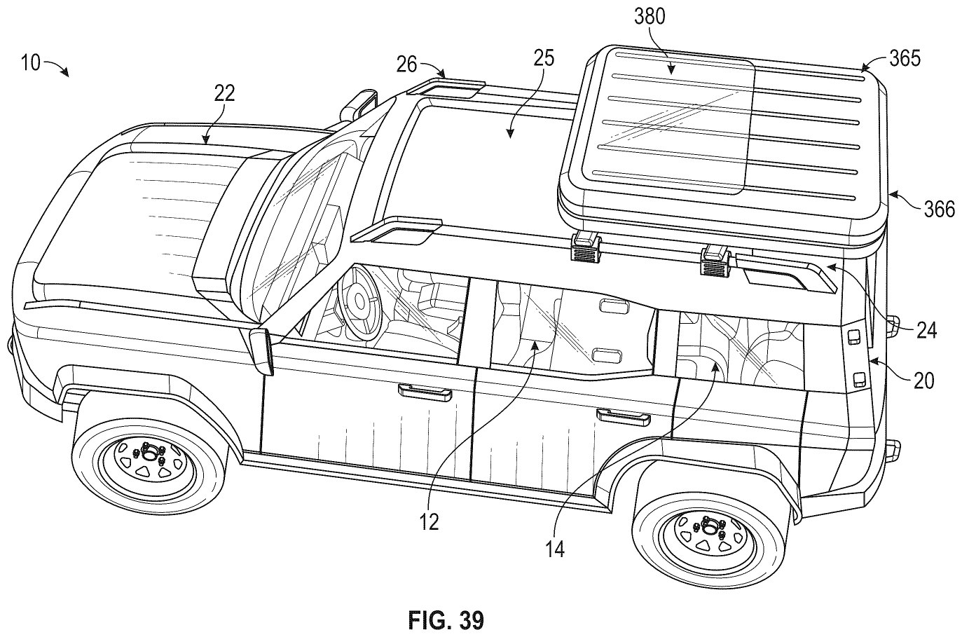

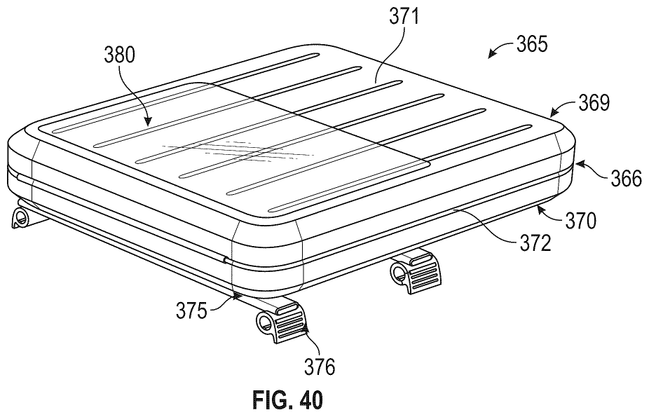

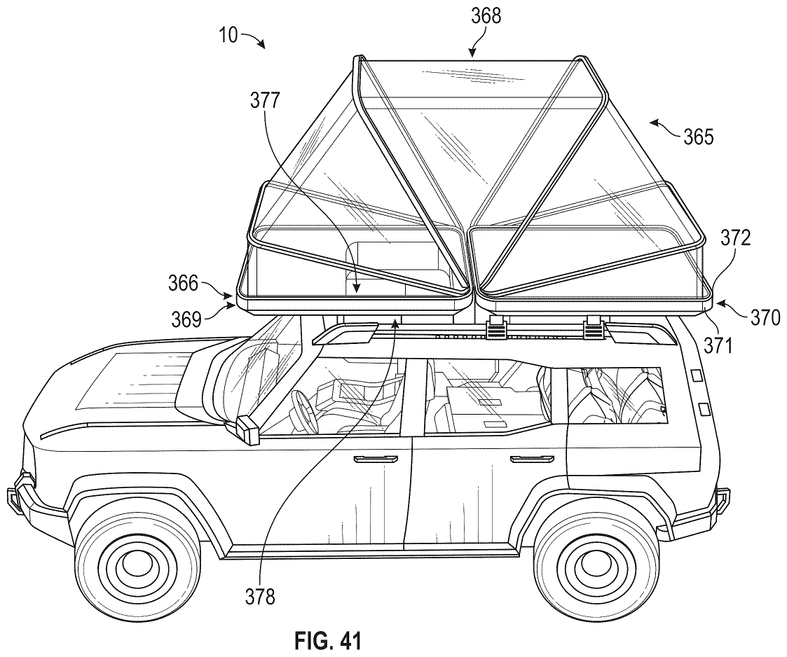

FIGS. 39-41 illustrate another exemplary sleeping platform 365. The sleeping platform 365 may be supported on the mounting system 26 of the vehicle 10. The sleeping platform may include a base portion 366 and a cover portion 368. The base portion 366 may include a first base section 369 and a second base section 370, which may be pivotably attached to one another to allow the sleeping platform 365 to move between a folded position (FIGS. 39 and 40) and an unfolded position (FIG. 41).

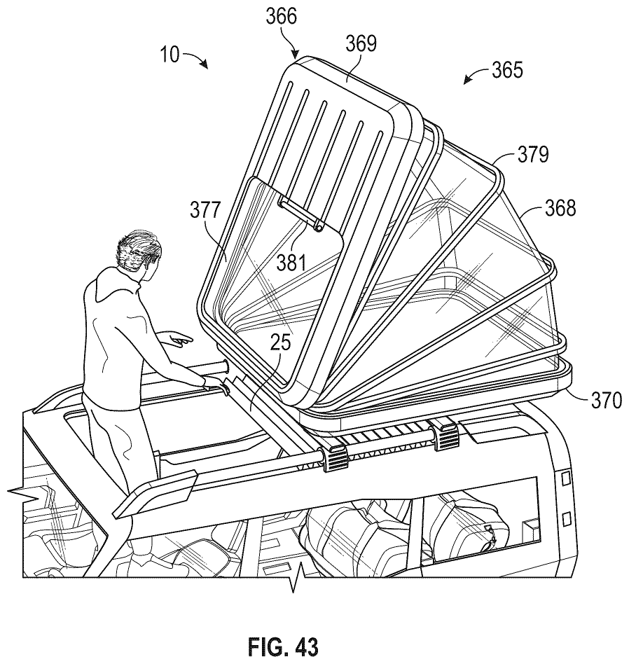

The base portion 366 may include a first side 371 and a second side 372 (shown best in FIG. 41). A removable panel 380 may be arranged on the first side 371 of the first base section 369. The removable panel 380 may extend over an opening 377 that extends through the first base section 369. When the removeable panel 380 is in place, it maintains a continuous surface with the first side 371. The removable panel 380 may be removed from the first base section 369 to reveal the opening 377 that extends through the first base section 369. The opening 377 may be sized to correspond to the uncovered portion of the sunroof opening when the sunroof panel 25 is in one of the open positions. The opening 377 may be configured to allow a user to access the sleeping platform 365 from the passenger compartment 12. A handle 381 may be arranged on a wall defining an inner perimeter the opening 377 (FIG. 43). As discussed further below, the handle 381 may be used to move the sleeping platform 365 from the folded position to the unfolded position.

As shown in FIG. 41, a seal component 378 may be positioned around the inner perimeter of the opening 377 when the sleeping platform 365 is in the unfolded position. The seal component 378 may extend downward from the opening 377 and at least partially into the vehicle 10 through an uncovered portion of the sunroof opening when the sunroof panel 25 is open. The seal component 378 may contact an inner perimeter of the uncovered portion of the sunroof opening to form a seal between the sleeping platform 365 and the vehicle 10.

Referring to FIG. 40, the first side 371 of the second base section 370 may be supported on the mounting system 26 by cross bars 375. The cross bars 375 may be attached to and span across the second base section 370 between the rails of the mounting system 26. The cross bars 375 may be spaced apart relative to one another. In this embodiment, one of the cross bars 375 may be positioned on a forward portion of the second base section 370 and a different one of the cross bars 375 may be positioned on a middle portion of the second base section 370. The cross bars 375 may serve to support the second base section 270 above the roof panel 24. A clamping mechanism 376 may be provided on each end of each cross bar 375 to secure the second base section 370 to the mounting system 26.

Referring to FIG. 41, the cover portion 368 may be attached to the second side 372 of the base portion 366. The cover portion 368 may extend across the entire length of the base portion 366. In one embodiment, the cover portion 368 may be integrated into the base portion 366.

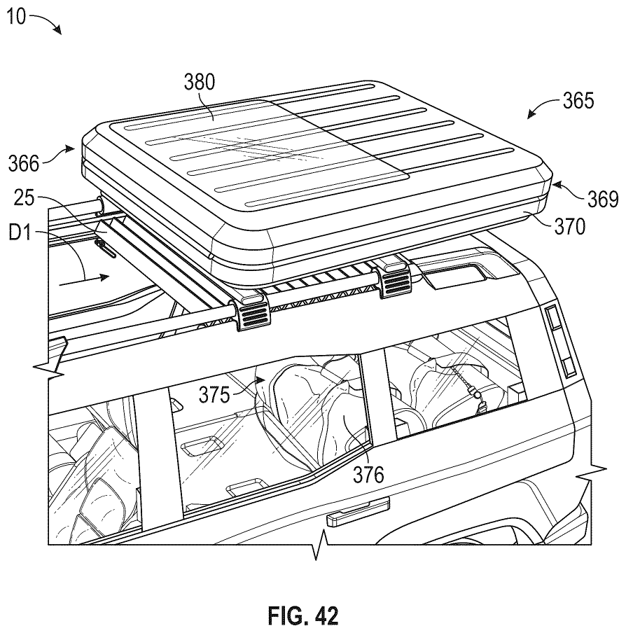

With reference to FIG. 42, before supporting the sleeping platform 365 on the roof panel 24 of the vehicle 10, the sunroof panel 24 may be moved in the first direction D1 to the first open position. The first open position may be sized to accommodate the seal component 378 of the sleeping platform 365. The sleeping platform 365, while in the folded position, may then be attached to the mounting system 26 on the roof panel 24.

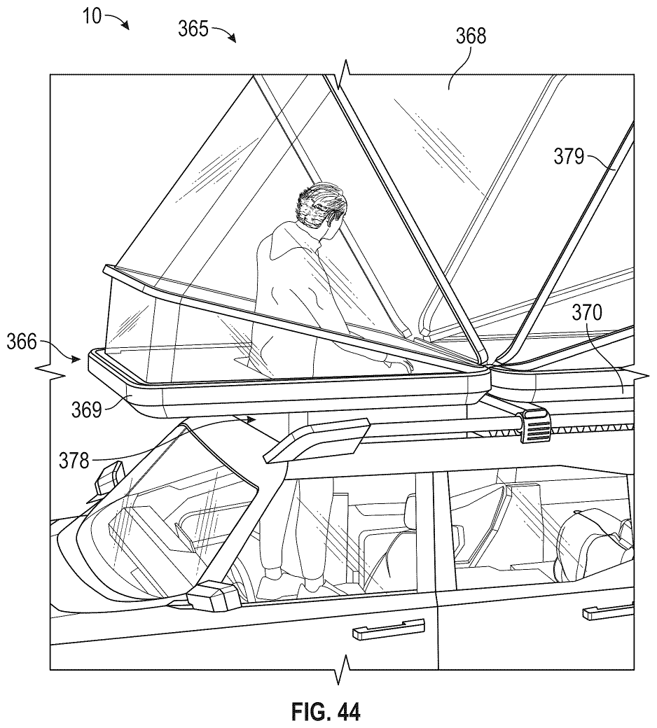

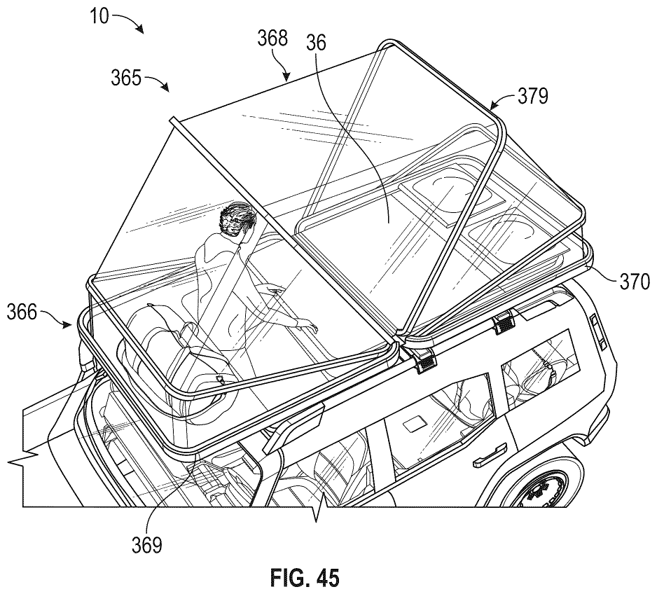

Referring to FIGS. 43-45, to move the sleeping platform 365 to the unfolded position, a user may stand up through the sunroof opening, remove the removable panel 380, and then use the handle 381 to pull the first base section 369 outward until the first base section 369 is fully extended and horizontally aligned with the second base section 370. As the sleeping platform 365 unfolds, cover frame bars 379 expand and stabilize the cover portion 368. Once the sleeping platform 365 is in the unfolded position, the seal component 378 may be deployed to form a seal between the sleeping platform 365 and the sunroof opening of the vehicle 10. With the first base section 369 and the second base section 370 horizontally aligned, a mattress 36 may be supported on the base portion 366.

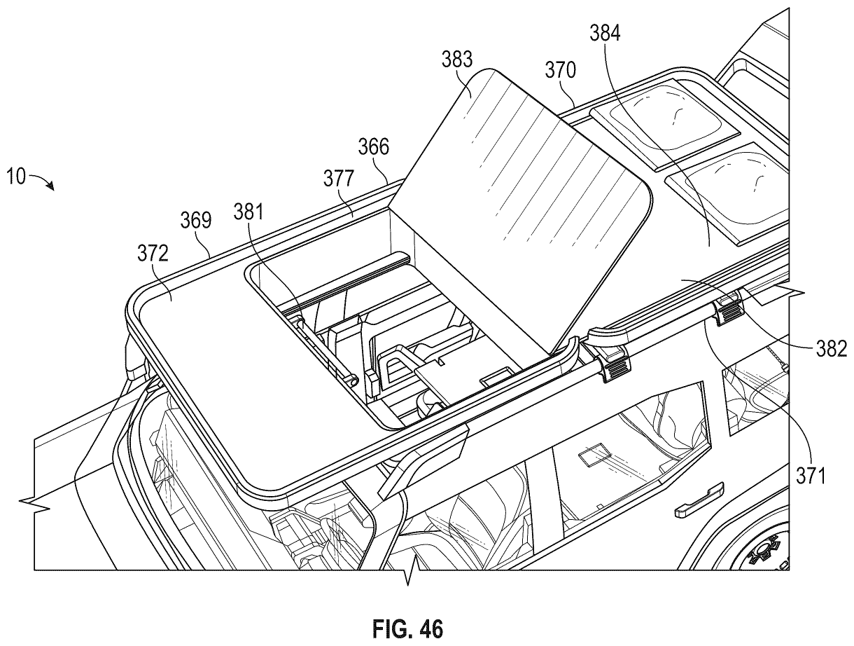

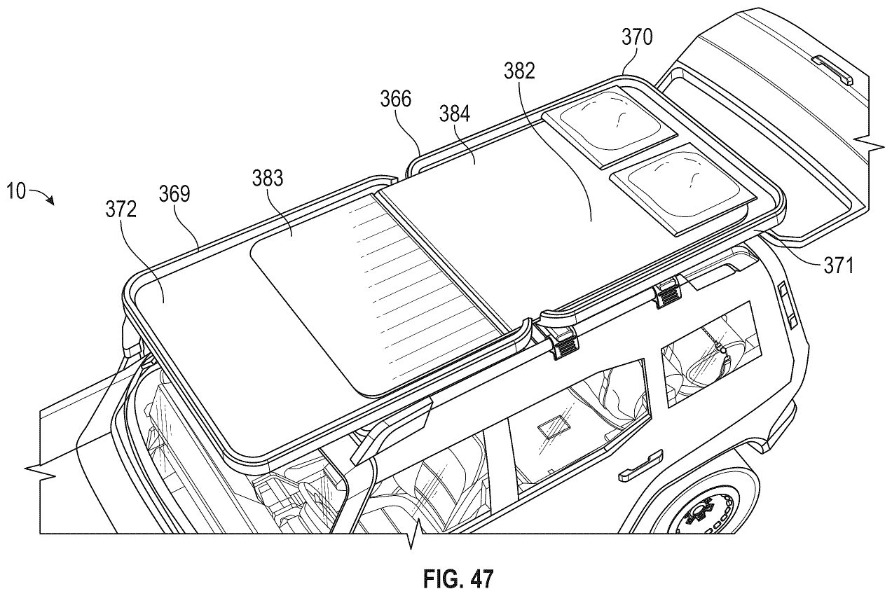

Referring to FIGS. 46-48, the sleeping platform 365 may include another exemplary mattress 382, which may be an inflatable mattress that is integrated into the base portion 366. The cover portion 368 is not shown in FIGS. 46 and 47 for illustrative purposes only. In this embodiment, the mattress 382 may be built into the second side 372 of the base portion 366. The mattress 382 may be flexible such that when deflated, the mattress 382 may align with the movement of the base portion 366 as the sleeping platform 365 moves between the folded position and the unfolded position. For example, the mattress 382 may be folded and unfolded with the sleeping platform 365 as it moves between the folded position and the unfolded position. In an embodiment, when the sleeping platform 365 is in the folded position, the mattress 382 may be sandwiched between the first and second base sections 369, 370 of the base portion 366, and, when the sleeping platform 365 is the unfolded position, the mattress 382 may be substantially planar with the first and second base sections 369, 370. The mattress 382 may be inflated when the sleeping platform 365 is in the unfolded position to provide a sleeping surface.

The mattress 382 may be divided into a first mattress portion 383 and a second mattress portion 384. The first mattress portion 383 and the second mattress portion 384 may be pivotably attached to one another at a location adjacent to the opening 377 in the first base section 369.

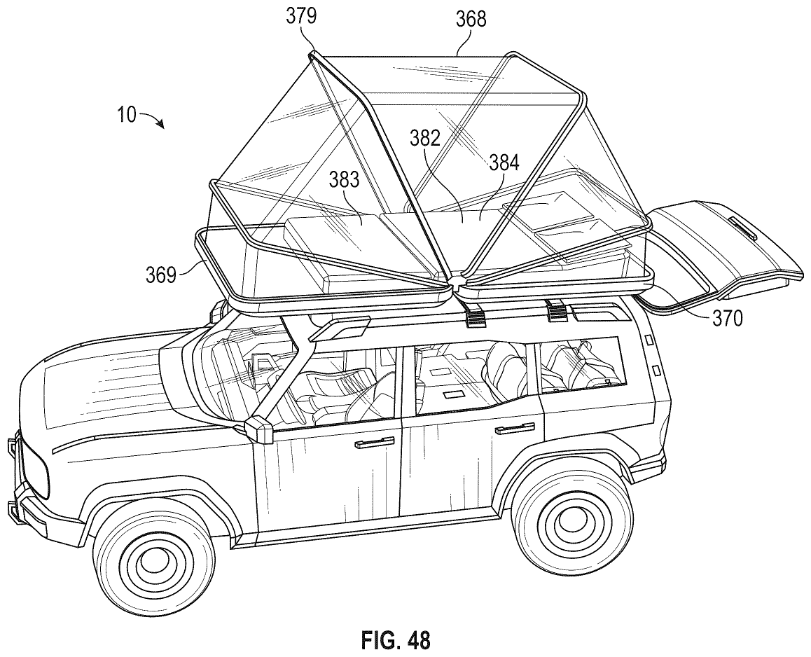

When the sleeping platform 365 is in the unfolded position and the mattress 382 is deflated, the first mattress portion 383 may be pivoted relative to the second mattress portion 384. As shown in FIG. 46, the first mattress portion 383 may be pivoted upward to reveal the opening 377. By pivoting the first mattress portion 383 upward relative to the second mattress portion 384, a user may access the sleeping platform 365 and/or the passenger compartment 12 through the opening 377. As shown in FIGS. 47 and 48, when a user is inside the sleeping platform 365, the first mattress portion 383 may be pivoted downward to cover the opening 377. The user may then inflate the mattress 382 to cause the first and second portions 383, 384 to expand and form a sleeping surface.

In an embodiment, a lower surface of the first mattress portion 383 may be lined with a durable shell material that is configured to prevent the first mattress portion 383 from sagging into or otherwise through the opening 377 during use of the mattress 382.

Like the sleeping platform 264, the sleeping platform 365 may be provided in addition to one of the sleeping platforms 28, 129 to provide separate sleeping spaces.

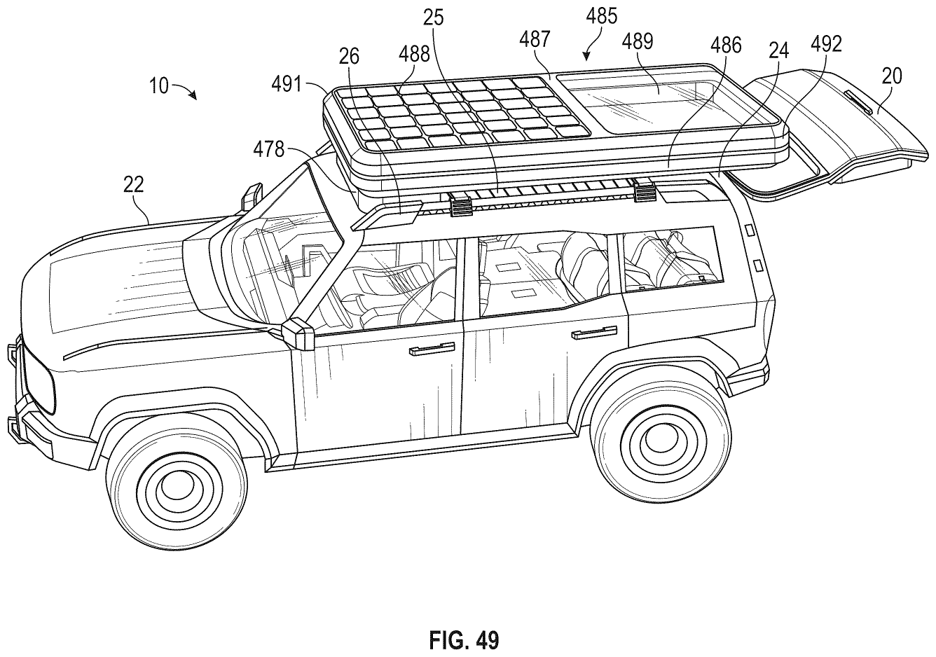

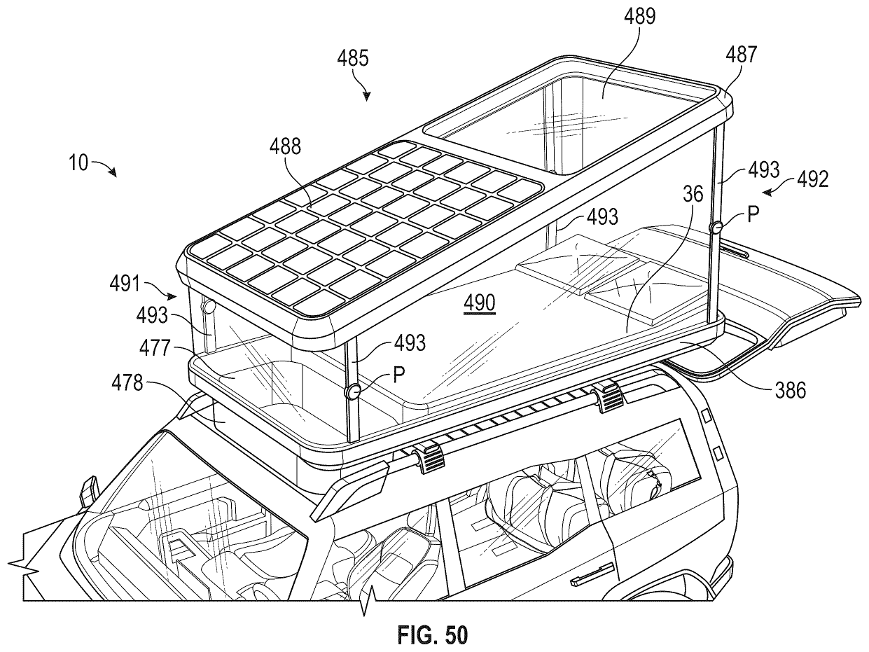

FIGS. 49 and 50 illustrate yet another exemplary sleeping platform 485. The sleeping platform 485 may be attached to the mounting system 26 of the vehicle 10 in the same manner as the sleeping platforms 264, 365 discussed above. The sleeping platform 485 may include a base portion 486 and a cover portion 487 that are moveable relative to one another to allow the sleeping platform 485 to move between a collapsed position (FIG. 49) and an expanded position (FIG. 50).

When in the collapsed position, the sleeping platform 485 may be in a compact configuration which reduces its profile on the roof panel 24 for transporting the sleeping platform 485 from one location to another. When in the expanded position, the sleeping platform 485 may provide an elevated area for supporting a mattress, such as the mattress 36, for example.

The base portion 486 may include an opening 477 that extends through the base portion 486. The opening 477 may be sized to correspond to the uncovered portion of the sunroof opening when the sunroof panel 25 is open. The opening 477 may be configured to allow a user to access the sleeping platform 485 from the passenger compartment 12.

A seal component 478 may be positioned around the inner perimeter of the opening 477. The seal component 478 may extend downward from the opening 477 and at least partially into the vehicle 10 through an uncovered portion of the sunroof opening when the sunroof panel 25 is open. The seal component 478 may be configured to form a seal between the sleeping platform 485 and the vehicle 10.

The cover portion 487 may include a solar panel 488 and a window 489. The solar panel 488 may serve as an energy source for charging user devices (e.g., phones, tablets, lights, etc.). The solar panel 488 could also be wired into the vehicle's electrical system to provide supplemental power. The window 489 may be transparent so that a user may view the exterior environment when using the sleeping platform 485.

A flexible wall portion 490 may be connected between the base portion 486 and the cover portion 487 to form an enclosed sleeping area when the sleeping platform 485 is in the expanded position. The flexible wall portion 490 may be made of a waterproof material that acts as a barrier between the interior and the exterior environments of the sleeping platform 485.

The sleeping platform 485 may extend between a first end portion 491 and a second end portion 492. A pair of foldable support legs 493 may be arranged on each end portion of the sleeping platform 485. Each foldable support leg 493 may be connected at a first location to the base portion 486 and at a second location to the cover portion 487. A pivot point P on each foldable support leg 493 may allow the foldable support legs 493 to fold and extend so that the sleeping platform 485 can move between the collapsed position and the expanded position. When extended, the foldable support legs 493 may hold the sleeping platform 485 in the expanded position.

In this embodiment, the foldable support legs 493 at the first end portion 491 may be shorter than the foldable support legs 493 at the second end portion 492 such that the cover portion 487 is sloped relative to the base portion 486 when the sleeping platform 485 is in the expanded position.

Referring to FIG. 49, when in the collapsed position, the foldable support legs 493 may be pivoted downward to bring the base portion 486 and the cover portion 487 into contact with one another. The flexible wall portion 490 may be sandwiched between the base portion 486 and the cover portion 487. In the collapsed position, the sleeping platform 485 is compact to minimize its profile on the roof panel 24.

To move the sleeping platform 485 to the expanded position, a user may push the cover portion 487 upward through the opening 477 in the base portion 486 until the foldable support legs 493 are fully extended. Moving the cover portion 487 upward simultaneously draws the flexible wall portion 490 upward, since the flexible wall portion 490 is connected to both the cover portion 487 and the base portion 486. This upward movement causes the flexible wall portion 490 to stretch or otherwise expand to create an enclosed sleeping area.

As shown in FIG. 50, when in the expanded position, the foldable support legs 493 are extended into a locked position to hold the cover portion 487 at an elevated portion above the base portion 486. The foldable support legs 493 maintain a fixed distance between the base portion 486 and the cover portion 487 to form an interior space for supporting a mattress 36.

Like the sleeping platforms 264, 365, the sleeping platform 485 may be provided in addition to one of the sleeping platforms 28, 129 to provide separate sleeping spaces.

The sleeping platforms of this disclosure provide sleeping surfaces for the interior and exterior of a vehicle. Among the other benefits, the sleeping platforms are moveable between different configurations and/or positions depending on the application.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle sleeping system, comprising:
a vehicle roof panel;
a mounting system secured to the vehicle roof panel; and
a sleeping platform supported on the mounting system, the sleeping platform moveable between a folded position and an unfolded position, the sleeping platform including a base portion and support legs, the support legs configured to attach to attachment points on a vehicle hood when in the unfolded position.

2. The vehicle sleeping system as recited in claim 1, wherein the base portion includes a first base section and a second base section that is pivotably attached to the first base section.

3. The vehicle sleeping system as recited in claim 2, wherein the support legs each include a first end and an opposite second end, the first end pivotably attached to a first side of the first base section at a first location, the second end releasably attached to the first side of the first base section at a second location.

4. The vehicle sleeping system as recited in claim 2, further comprising cross bars attached to a first side of the second base section, the cross bars configured to support the sleeping platform above the vehicle roof panel.

5. The vehicle sleeping system as recited in claim 4, wherein a first one of the cross bars is positioned on a forward portion of the second base section, a second one of the cross bars is positioned on a middle portion of the second base section, and a third one of the cross bars is positioned on a rear portion of the second base section.

6. The vehicle sleeping system as recited in claim 5, further comprising a sunroof panel configured to extend and retract between a fully closed position in which a sunroof opening is covered and a plurality of open positions in which at least a portion of the sunroof opening is uncovered, wherein the base portion includes an opening that extends through the second base section, the opening sized to correspond to the uncovered portion of the sunroof opening.

7. The vehicle sleeping system as recited in claim 6, further comprising a seal component positioned around an inner perimeter of the opening, wherein the seal component extends from the opening between the second cross bar and the third cross bar.

8. The vehicle sleeping system as recited in claim 4, further comprising a clamping mechanism provided on each end of the cross bars, the clamping mechanism configured to secure the cross bars to the mounting system.

9. The vehicle sleeping system as recited in claim 2, further comprising a cover portion of the sleeping platform, wherein the cover portion is attached to and extends across a second side of the first base section and the second base section.

10. The vehicle sleeping system as recited in claim 9, wherein, when in the folded position, the first base section is folded against the second base section, and the cover portion is sandwiched between the first base section and the second base section.

11. The vehicle sleeping system as recited in claim 9, wherein, when in the unfolded position, the first base section extends outward away from the second base section over the vehicle hood, and an end of each support leg is releasably attachable to one of the attachment points to hold the first base section over the vehicle hood.

12. A vehicle sleeping system, comprising:
a vehicle roof panel;
a mounting system secured to the vehicle roof panel; and
a sleeping platform supported on the mounting system, the sleeping platform including a base portion having a first base section and a second base section that is pivotably attached to the first base section, the sleeping platform moveable between a folded position in which the first base section is folded against the second base section and an unfolded position in which the first base section extends outward away from the second base section over a vehicle hood.

13. The vehicle sleeping system as recited in claim 12, further comprising support legs of the sleeping platform, the support legs each including a first end and an opposite second end, the first end pivotably attached to a first side of the first base section at a first location, the second end releasably attached to the first side of the first base section at a second location.

14. The vehicle sleeping system as recited in claim 13, wherein the support legs are configured to attach to attachment points on the vehicle hood when in the unfolded position.

15. The vehicle sleeping system as recited in claim 14, wherein, when in the unfolded position, the second end of each support leg is releasably attachable to one of the attachment points to hold first base section over the vehicle hood.

16. The vehicle sleeping system as recited in claim 12, further comprising a cover portion of the sleeping platform, wherein the cover portion is attached to and extends across the first base section and the second base section.

17. The vehicle sleeping system as recited in claim 16, wherein, when in the folded position, the cover portion is sandwiched between the first base section and the second base section.

18. The vehicle sleeping system as recited in claim 16, wherein, when in the unfolded position, the cover portion is expanded outward by cover frame bars.

19. The vehicle sleeping system as recited in claim 12, further comprising a sunroof panel configured to extend and retract between a fully closed position in which a sunroof opening is covered and a plurality of open positions in which at least a portion of the sunroof opening is uncovered, wherein the base portion includes an opening that extends through the second base section, the opening sized to correspond to the uncovered portion of the sunroof opening.

20. The vehicle sleeping system as recited in claim 19, wherein the opening is configured to allow access to the sleeping platform from within a passenger compartment of a vehicle.
